(19) United States
(12) Patent Application Publication
(10) Pub. No.: US 2021/0173292 A1
(43) Pub. Date: Jun. 10, 2021

(54) PROJECTION SYSTEM AND PROJECTOR

(71) Applicant: SEIKO EPSON CORPORATION, Tokyo (JP)

(72) Inventor: Hirotaka YANAGISAWA, Azumino-shi (JP)

(73) Assignee: SEIKO EPSON CORPORATION, Tokyo (JP)

(21) Appl. No.: 17/112,157

(22) Filed: Dec. 4, 2020

(30) Foreign Application Priority Data
Dec. 6, 2019 (JP) 2019-221006

(51) Int. Cl. G03B 21/28; G02B 13/16; G02B 17/08

(52) U.S. Cl. CPC G03B 21/28; G02B 17/08; G02B 13/16

(57) ABSTRACT

A projection system includes a first optical system, a second optical system disposed at an enlargement side of the first optical system, and a third optical system disposed at the enlargement side of the second optical system. An intermediate image is formed between the first optical system and the second optical system. The first optical system includes a first lens disposed in a position closest to the enlargement side in the first optical system. The second optical system includes a mirror having a concave curved surface. The third optical system includes a second lens disposed in a position closest to the reduction side in the third optical system and having negative power. An effective range of the first lens is located at one side of an optical axis of the first optical system. An effective range of the second lens is located at the other side of the optical axis.

The present application is based on, and claims priority from JP Application Serial Number 2019-221006 filed Dec. 6, 2019, the disclosure of which is hereby incorporated by reference herein in its entirety.

### BACKGROUND

### 1. Technical Field

The present disclosure relates to a projection system and a projector.

### 2. Related Art

JP-A-2010-20344 describes a projector that enlarges and projects a projection image formed by an image formation section via a projection system. The projection system described in JP-A-2010-20344 is formed of a first optical system and a second optical system sequentially arranged from the reduction side toward the enlargement side. The first optical system includes a refractive system. The second optical system is formed of one mirror having a concave curved shape. The image formation section includes a light source and a light valve. The image formation section forms a projection image in the reduction-side image formation plane of the projection system. The projection system forms an intermediate image in a position between the first optical system and the reflection surface of the mirror and projects a final image conjugate with the intermediate image on a screen disposed on the enlargement-side image formation plane of the projection system. The mirror reflects the light rays from the light source in an upward direction that intersects the optical axis of the first optical system.

When the projector described in JP-A-2010-20344 projects the final image on the screen, the distance between an upper portion of the screen and the mirror is longer than the distance between a lower portion of the screen and the mirror. Further, in the description of JP-A-2010-20344, in which the final image conjugate with the intermediate image is formed on the screen based on the effect of only one mirror, the difference in distance described above causes the light ray that reaches the upper portion of the screen and the light ray that reaches the lower portion of the screen to form the intermediate image in different positions in the direction of the optical axis of the first optical system. That is, the light ray that reaches the upper portion of the screen has a longer distance between the intermediate image and the mirror, and the light ray that reaches the lower portion of the screen has a shorter distance between the intermediate image and the mirror. The intermediate image therefore inclines in the direction along the optical axis of the first optical system.

When the projection distance of the projection system is shortened, the intermediate image inclines in the direction along the optical axis of the first optical system by a greater amount and expands in the direction of the optical axis, resulting in an increase in the size of the intermediate image. This causes a problem of the necessity of increasing the distance between the first optical system and the second optical system in correspondence with the size of the intermediate image. Further, since the light flux formed of the light rays diverges in the segment from the position where the intermediate image is formed toward the enlargement side, the increase in the size of the intermediate image causes a problem of the necessity of increasing the size of the mirror to capture the outside portion of the light flux.

### SUMMARY

To solve the problems described above, a projection system according to an aspect of the present disclosure includes a first optical system, a second optical system disposed at an enlargement side of the first optical system, and a third optical system disposed at the enlargement side of the second optical system. An intermediate image conjugate with a reduction-side image formation plane is formed between the first optical system and the second optical system. The first optical system includes a first lens disposed in a position closest to the enlargement side in the first optical system. The second optical system includes a mirror having a concave curved surface. The third optical system includes a second lens disposed in a position closest to the reduction side in the third optical system, the second lens having negative power. An effective range of the first lens is located at one side of an optical axis of the first optical system. An effective range of the second lens is located at other side of the optical axis.

A projector according to another aspect of the present disclosure includes a light source, a light modulator modulating light emitted from the light source to form an image on the reduction-side image formation plane, and the projection system described above, which projects the image.

### BRIEF DESCRIPTION OF THE DRAWINGS

FIG. 1 is a schematic configuration diagram of a projector including a projection system according to the present disclosure.

FIG. 2 is a light ray diagram of the light rays passing through the entire projection system according to Example 1.

FIG. 3 is a light ray diagram of the light rays passing through the projection system according to Example 1.

FIG. 4 is a light ray diagram in the vicinity of a second optical system and a third optical system.

FIG. 5 shows the enlargement-side MTF of the projection system according to Example 1.

FIG. 6 is a light ray diagram of the light rays passing through the entire projection system according to Example 2.

FIG. 7 is a light ray diagram of the light rays passing through the projection system according to Example 2.

FIG. 8 is a light ray diagram in the vicinity of the second optical system and the third optical system.

FIG. 9 shows the enlargement-side MTF of the projection system according to Example 2.

FIG. 10 is a light ray diagram of the light rays passing through the entire projection system according to Example 3.

FIG. 11 is a light ray diagram of the light rays passing through the projection system according to Example 3.

FIG. 12 is a light ray diagram in the vicinity of the second optical system and the third optical system.

FIG. 13 shows the enlargement-side MTF of the projection system according to Example 3.

FIG. 14 is a light ray diagram of the light rays passing through the entire projection system according to Example 4.

FIG. 15 is a light ray diagram of the light rays passing through the projection system according to Example 4.

FIG. 16 is a light ray diagram in the vicinity of the second optical system and the third optical system.

FIG. 17 shows the enlargement-side MTF of the projection system according to Example 4.

FIG. 18 is a light ray diagram of the light rays passing through the entire projection system according to Example 5.

FIG. 19 is a light ray diagram of the light rays passing through the projection system according to Example 5.

FIG. 20 is a light ray diagram in the vicinity of the second optical system and the third optical system.

FIG. 21 shows the enlargement-side MTF of the projection system according to Example 5.

### DESCRIPTION OF EXEMPLARY EMBODIMENTS

A projection system and a projector according to embodiments of the present disclosure will be described below in detail with reference to the drawings.

### Projector

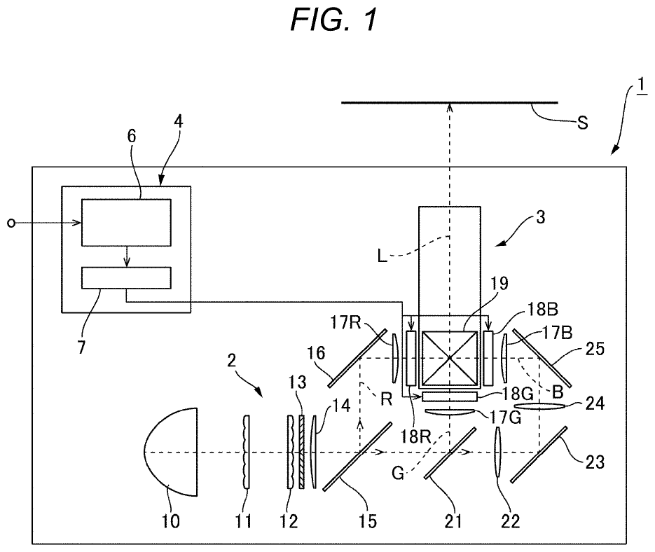

FIG. 1 is a schematic configuration diagram of a projector including a projection system 3 according to the present disclosure. A projector 1 includes an image formation section 2, which generates a projection image to be projected on a screen S, a projection system 3, which enlarges the projection image and projects the enlarged image on the screen S, and a controller 4, which controls the action of the image formation section 2, as shown in FIG. 1.

### Image Generation Optical System and Controller

The image formation section 2 includes a light source 10, a first optical integration lens 11, a second optical integration lens 12, a polarization converter 13, and a superimposing lens 14. The light source 10 is formed, for example, of an ultrahigh-pressure mercury lamp or a solid-state light source. The first optical integration lens 11 and the second optical integration lens 12 each include a plurality of lens elements arranged in an array. The first optical integration lens 11 divides the light flux from the light source 10 into a plurality of light fluxes. The lens elements of the first optical integration lens 11 focus the light flux from the light source 10 in the vicinity of the lens elements of the second optical integration lens 12.

The polarization converter 13 converts the light from the second optical integration lens 12 into predetermined linearly polarized light. The superimposing lens 14 superimposes images of the lens elements of the first optical integration lens 11 on one another in a display area of each of liquid crystal panels 18R, 18G, and 18B, which will be described later, via the second optical integration lens 12.

The image formation section 2 further includes a first dichroic mirror 15, a reflection mirror 16, a field lens 17R, and the liquid crystal panel 18R. The first dichroic mirror 15 reflects R light, which is part of the light rays incident via the superimposing lens 14, and transmits G light and B light, which are part of the light rays incident via the superimposing lens 14. The R light reflected off the first dichroic mirror 15 travels via the reflection mirror 16 and the field lens 17R and is incident on the liquid crystal panel 18R. The liquid crystal panel 18R is a light modulator. The liquid crystal panel 18R modulates the R light in accordance with an image signal to form a red projection image.

The image formation section 2 further includes a second dichroic mirror 21, a field lens 17G, and the liquid crystal panel 18G. The second dichroic mirror 21 reflects the G light, which is part of the light rays via the first dichroic mirror 15, and transmits the B light, which is part of the light rays via the first dichroic mirror 15. The G light reflected off the second dichroic mirror 21 passes through the field lens 17G and is incident on the liquid crystal panel 18G. The liquid crystal panel 18G is a light modulator. The liquid crystal panel 18G modulates the G light in accordance with an image signal to form a green projection image.

The image formation section 2 further includes a relay lens 22, a reflection mirror 23, a relay lens 24, a reflection mirror 25, a field lens 17B, and the liquid crystal panel 18B. The B light having passed through the second dichroic mirror 21 travels via the relay lens 22, the reflection mirror 23, the relay lens 24, the reflection mirror 25, and the field lens 17B and is incident on the liquid crystal panel 18B. The liquid crystal panel 18B is a light modulator. The liquid crystal panel 18B modulates the B light in accordance with an image signal to form a blue projection image.

The liquid crystal panels 18R, 18G, and 18B surround a cross dichroic prism 19 in such a way that the liquid crystal panels 18R, 18G, and 18B face three sides of the cross dichroic prism 19. The cross dichroic prism 19, which is a prism for light combination, produces a projection image that is the combination of the light modulated by the liquid crystal panel 18R, the light modulated by the liquid crystal panel 18G, and the light modulated by the liquid crystal panel 18B.

The cross dichroic prism 19 forms part of the projection system 3. The projection system 3 enlarges and projects the combined projection image (images formed by liquid crystal panels 18R, 18G, and 18B) from the cross dichroic prism 19 on the screen S. The screen S is the enlargement-side image formation plane of the projection system 3.

The controller 4 includes an image processor 6, to which an external image signal, such as a video signal, is inputted, and a display driver 7, which drives the liquid crystal panels 18R, 18G, and 18B based on image signals outputted from the image processor 6.

The image processor 6 converts the image signal inputted from an external apparatus into image signals each containing grayscales and other factors of the corresponding color. The display driver 7 operates the liquid crystal panels 18R, 18G, and 18B based on the color projection image signals outputted from the image processor 6. The image processor 6 thus causes the liquid crystal panels 18R, 18G, and 18B to display projection images corresponding to the image signals.

### Projection System

The projection system 3 will next be described. Examples 1 to 5 will be hereinafter described as examples of the configuration of the projection system 3 incorporated in the projector 1. In the light ray diagram of the light rays passing through the projection system in each of Examples, the liquid crystal panels 18R, 18G, and 18B are expressed as light modulation devices 18.

### Example 1

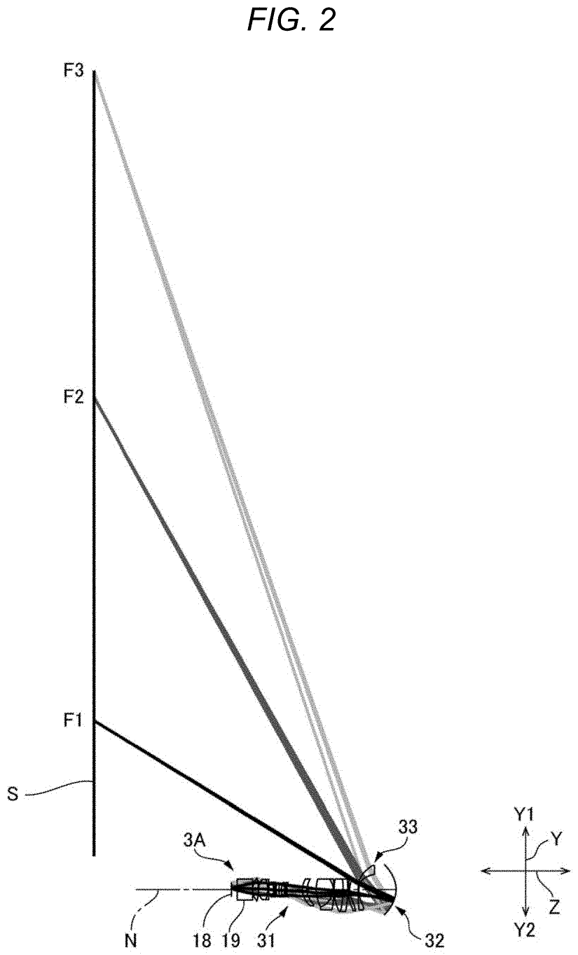

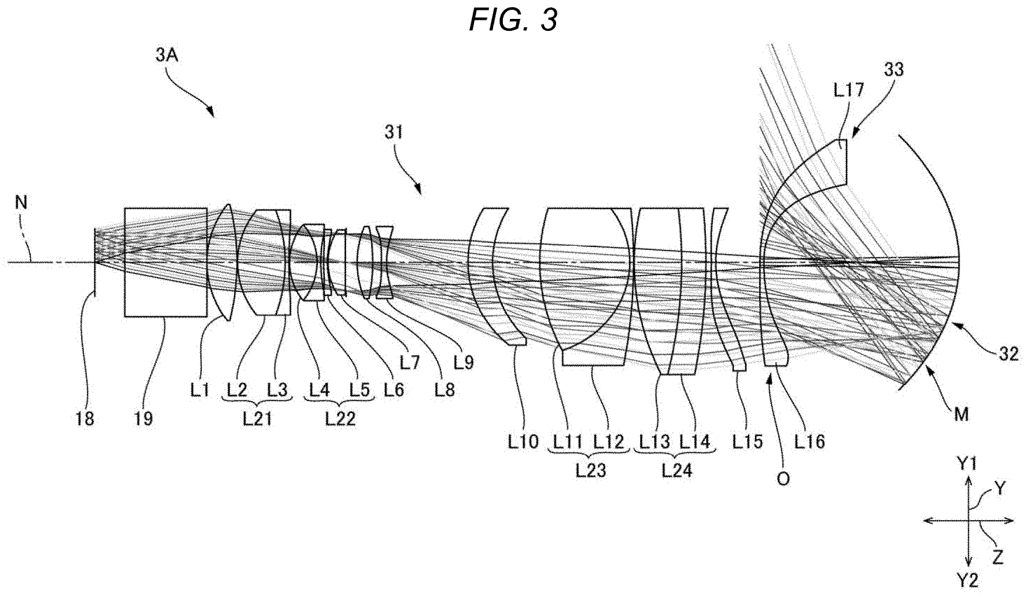

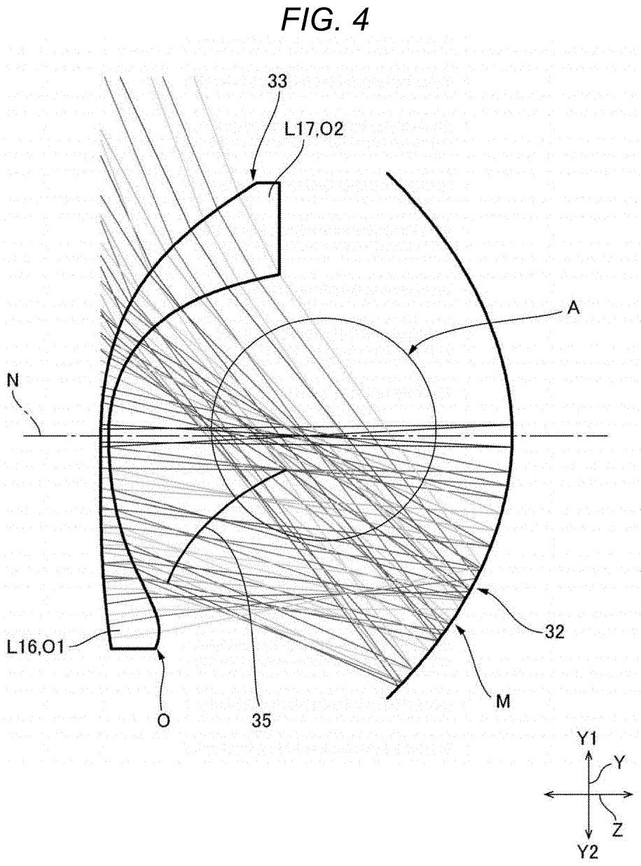

FIG. 2 is a light ray diagram diagrammatically showing the entire projection system according to Example 1. FIG. 2 diagrammatically shows light fluxes that exit out of a projection system 3A according to the present example and reach the screen S in the form of light fluxes F1 to F3. The light flux F1 is a light flux that reaches a smallest image height position. The light flux F3 is a light flux that reaches a largest image height position. The light flux F2 is a light flux that reaches a position between the position that the light flux F1 reaches and the position that the light flux F3 reaches. FIG. 3 is a light ray diagram of the light rays passing through the projection system 3A according to Example 1. FIG. 4 is a light ray diagram of the light rays passing through the lens located in a position closest to the enlargement side in a first optical system, a second optical system, and a third optical system.

The projection system 3A according to the present example is formed of a first optical system 31, a second optical system 32, and a third optical system 33 sequentially arranged from the reduction side toward the enlargement side, as shown in FIG. 3. The first optical system 31 is a refractive optical system including a plurality of lenses. The second optical system 32 includes a mirror M having a concave curved surface. The third optical system 33 has negative power. The first optical system 31 forms an intermediate image 35, which is conjugate with the reduction-side image formation plane, between the first optical system 31 and the second optical system 32, as shown in FIG. 4. The second optical system 32 and the third optical system 33 form a final image conjugate with the intermediate image 35 in the enlargement-side image formation plane.

The liquid crystal panels 18 of the image formation section 2 are disposed in the reduction-side image formation plane. The liquid crystal panels 18 form projection images on one side of an optical axis N of the first optical system 31. The intermediate image 35 is formed at the other side of the optical axis N of the first optical system 31. The enlargement-side image formation plane is provided at the one side of the optical axis N of the first optical system 31. The screen S is disposed in the enlargement-side image formation plane.

In the following description, three axes perpendicular to one another are called axes X, Y, and Z for convenience. The optical axis direction along the optical axis N of the first optical system 31 is called an axis-Z direction. One side of the optical axis N is called an upper side Y1 of the axis-Y direction, and the other side of the optical axis Y is called a lower side Y2 of the axis-Y direction. A plane perpendicular to the axis X and containing the axes Y and Z is called a plane YZ. The liquid crystal panels 18 therefore form projection images at the upper side Y1 of the optical axis N. The intermediate image 35 is formed at the lower side Y2 of the optical axis N. The screen S is located at the upper side Y1 of the optical axis N. The lateral direction of the screen S coincides with the axis-X direction. The intermediate image 35 is the image formed on the screen S that is not enlarged but turned upside down in the axis-Y direction. FIGS. 2, 3, and 4 are light ray diagrams in the plane YZ.

The first optical system 31 includes the cross dichroic prism 19 and 16 lenses L1 to L16, as shown in FIG. 3. The lenses L1 to L16 are arranged in the presented order from the reduction side toward the enlargement side. In the present example, the lenses L2 and L3 are bonded to each other to form a first doublet L21. The lenses L4 and L5 are bonded to each other to form a second doublet L22. The lenses L11 and L12 are bonded to each other to form a third doublet L23. The lenses L13 and L14 are bonded to each other to form a fourth doublet L24. A light flux passage area of the lens L16 (first lens) is located at the lower side Y2 of the optical axis N.

The second optical system 32 is formed of one mirror M, as shown in FIG. 4. The mirror M reflects the light rays from the first optical system 31 toward the upper side Y1.

The third optical system 33 is formed of one lens L17 (second lens) having a meniscus shape. The lens L17 is disposed at the upper side Y1 of the optical axis N of the first optical system 31. The reduction-side surface of the lens L17 has a concave curved surface recessed toward the enlargement side. The reduction-side surface of the lens L17 has negative power. The reduction-side surface of the lens L17 is an aspheric surface. The enlargement-side surface of the lens L17 is a convex curved surface protruding toward the enlargement side. The enlargement-side surface of the lens L17 is an aspheric surface. The thickness of the lens L17 increases with distance from the optical axis N of the first optical system 31 toward the upper side Y1. In other words, the light rays reflected off the mirror M and passing through the lens L17 each travel along an optical path length in the lens L17 that increases with distance from the optical axis N of the first optical system 31 toward the upper side Y1.

The lens L16 of the first optical system 31 and the lens L17 of the third optical system 33 are each provided as part of one optical element O, which is disposed at the opposite side of the second optical system 32 with respect to the intermediate image 35 along the optical axis N of the first optical system 31. That is, the lens L16 of the first optical system 31 is a first optical element section O1 of the optical element O, which is the section on the lower side Y2 of the optical axis N of the first optical system 31. The lens L17 of the third optical system 33 is a second optical element section O2 of the optical element O, which is the section on the upper side Y1 of the optical axis N of the first optical system 31.

### Lens Data

Data on the lenses of the projection system 3A are as follows: The surfaces of the lenses are numbered sequentially from the reduction side toward the enlargement side. Reference characters are given to the lenses and the mirror. Data labeled with surface numbers that do not correspond to the lenses or the mirror are dummy data. Reference character R denotes the radius of curvature of a lens surface or a mirror surface. Reference character D denotes the on-axis distance between surfaces. Reference character C denotes the effective diameter of a lens surface or a mirror surface. Reference characters R, D, and C are each expressed in millimeters.

| Reference | Surface | | | | Glass | Refraction/ | |
|---|---|---|---|---|---|---|---|
| character | number | Shape | R | D | material | reflection | C |
| | 0 | Spherical | Infinity | 0.0000 | | Refraction | 0.0000 |
| | 1 | Spherical | Infinity | 9.5000 | | Refraction | 11.7000 |
| 19 | 2 | Spherical | Infinity | 25.9100 | SBSL7 | Refraction | 13.8197 |
| | 3 | Spherical | Infinity | 0.0000 | | Refraction | 17.5754 |
| L1 | 4 | Spherical | 34.5867 | 9.5095 | SFPL51 | Refraction | 18.8176 |
| | 5 | Spherical | −90.8873 | 0.2000 | | Refraction | 18.6592 |
| L2 | 6 | Spherical | 30.5520 | 15.0000 | SFSL5 | Refraction | 16.9634 |
| L3 | 7 | Spherical | −57.2273 | 1.2000 | STIH6 | Refraction | 14.0000 |
| | 8 | Spherical | 173.6241 | 0.2000 | | Refraction | 13.2517 |
| L4 | 9 | Spherical | 22.4842 | 8.6756 | SBSL7 | Refraction | 12.1460 |
| L5 | 10 | Spherical | −22.0071 | 1.2000 | TAFD25 | Refraction | 11.2705 |
| | 11 | Spherical | 51.1513 | 0.8782 | | Refraction | 10.3777 |
| L6 | 12 | Aspheric | 49.6558 | 1.2000 | LBAL35 | Refraction | 10.3900 |
| | | surface | | | | | |
| | 13 | Aspheric | 25.2762 | 0.2000 | | Refraction | 10.2218 |
| | | surface | | | | | |
| L7 | 14 | Spherical | 22.2953 | 5.5069 | SFSL5 | Refraction | 10.2632 |
| | 15 | Spherical | −846.7643 | 0.2000 | | Refraction | 9.8443 |
| | 16 | Spherical | Infinity | 3.5109 | | Refraction | 9.7876 |
| L8 | 17 | Spherical | 35.2243 | 4.9014 | STIH53 | Refraction | 11.4321 |
| | 18 | Spherical | −66.1835 | 2.7394 | | Refraction | 11.4134 |
| L9 | 19 | Aspheric | −318.9262 | 1.6426 | LLAM60 | Refraction | 10. 9985 |
| | | surface | | | | | |
| | 20 | Aspheric | 26.3290 | 16.1984 | | Refraction | 11.4618 |
| | | surface | | | | | |
| | 21 | Spherical | Infinity | 9.5039 | | Refraction | 17.3660 |
| L10 | 22 | Spherical | 37.9392 | 7.8029 | STIM22 | Refraction | 27.0207 |
| | 23 | Spherical | 37.9749 | 14.8804 | | Refraction | 25.7801 |
| L11 | 24 | Spherical | 69.0185 | 28.4144 | STIM2 | Refraction | 29.7336 |
| L12 | 25 | Spherical | −32.3562 | 1.2000 | STIH6 | Refraction | 29.7945 |
| | 26 | Spherical | −202.3140 | 0.2000 | | Refraction | 33.8303 |
| L13 | 27 | Spherical | 91.9413 | 14.9604 | STIL25 | Refraction | 36.6890 |
| L14 | 28 | Spherical | −172.7823 | 7.6862 | STIH6 | Refraction | 36.6662 |
| | 29 | Spherical | −211.4567 | 1.7202 | | Refraction | 36.8449 |
| L15 | 30 | Aspheric | −334.1939 | 1.3786 | □Z-E48R□ | Refraction | 35.5825 |
| | | surface | | | | | |
| | 31 | Aspheric | 38.6610 | 13.9841 | | Refraction | 34.8094 |
| | | surface | | | | | |
| L16 | 32 | Aspheric | −547.4767 | 1.2000 | □Z-E48R□ | Refraction | 33.9637 |
| | | surface | | | | | |
| | 33 | Aspheric | 70.0493 | 61.6960 | | Refraction | 32.9483 |
| | | surface | | | | | |
| M | 34 | Aspheric | −51.9308 | −61.6960 | | Reflection | 42.1244 |
| | | surface | | | | | |
| | 35 | Spherical | Infinity | 0.0000 | | Refraction | 68.6960 |
| L17 | 36 | Aspheric | 31.5643 | −1.2000 | □Z-E48R□ | Refraction | 27.1036 |
| | | surface | | | | | |
| | 37 | Aspheric | 66.6691 | 0.0000 | | Refraction | 40.5464 |
| | | surface | | | | | |
| | 38 | Spherical | Infinity | −439.3040 | | Refraction | 101.5136 |
| | 39 | Spherical | Infinity | 0.0000 | | Refraction | 1371.0322 |

The aspheric constants of each of the aspheric surfaces are listed below.

| Surface number | S12 | S13 | S19 | S20 |
|---|---|---|---|---|
| Radius of | 49.65582381 | 25.27621931 | −318.9262388 | 26.32901912 |
| curvature in | | | | |
| axis-Y direction | | | | |
| Conic constant | 1.568 | −1.3 | −1 | −0.88 |
| (K) | | | | |
| Fourth-order | −1.90452E−04 | −1.65330E−04 | −7.75605E−05 | −4.50156E−05 |
| coefficient (A) | | | | |
| Sixth-order | 1.41580E−06 | 1.44462E−06 | 9.01620E−09 | 7.03003E−08 |
| coefficient (B) | | | | |
| Eighth-order | −5.56606E−09 | −6.76700E−09 | −4.30650E−11 | 1.75774E−11 |
| coefficient (C) | | | | |
| Tenth-order | 1.12856E−11 | 1.47249E−11 | | |
| coefficient (D) | | | | |

| Surface number | S30 | S31 | S32 | S33 |
|---|---|---|---|---|
| Radius of | 334.1939158 | 38.66100388 | −547.476701 | 70.0493315 |
| curvature in | | | | |
| axis-Y direction | | | | |
| Conic constant | 80.93042591 | 0 | −179329.1453 | 2.476873572 |
| (K) | | | | |
| Fourth-order | 1.56186E−05 | −1.08312E−05 | 1.56783E−06 | 3.01840E−07 |
| coefficient (A) | | | | |
| Sixth-order | −1.62590E−08 | 1.52873E−08 | −2.89746E−10 | 3.71758E−09 |
| coefficient (B) | | | | |
| Eighth-order | 1.79446E−11 | −1.99997E−11 | −9.51446E−14 | −5.66030E−12 |
| coefficient (C) | | | | |
| Tenth-order | −1.92132E−14 | 4.71234E−15 | | |
| coefficient (D) | | | | |
| Twelfth-order | 1.18169E−17 | 5.83566E−18 | | |
| coefficient (E) | | | | |
| Fourteenth-order | −2.76801E−21 | −2.98566E−21 | | |
| coefficient (F) | | | | |

| Surface number | S34 | S36 | S37 |
|---|---|---|---|
| Radius of | −51.93079714 | 31.56428165 | 66.66912913 |
| curvature in | | | |
| axis-Y direction | | | |
| Conic constant | −1.119965114 | 0.225510562 | −3.294841957 |
| (K) | | | |
| Fourth-order | 2.73444E−07 | 9.66883E−06 | 3.95104E−06 |
| coefficient (A) | | | |
| Sixth-order | −3.94761E−10 | −1.03190E−08 | 4.69353E−10 |
| coefficient (B) | | | |
| Eighth-order | 1.46325E−13 | 2.50100E−11 | −2.86696E−13 |
| coefficient (C) | | | |
| Tenth-order | −4.37368E−17 | | |
| coefficient (D) | | | |
| Twelfth-order | 4.91882E−21 | | |
| coefficient (E) | | | |

A maximum object height, brightness, a mirror radius, a final lens radius, a lens overall length, and TR of the projection system 3A are as follows: The maximum object height is the dimension to the farthest point from the optical axis N of the projection system 3A in an image formation area on the surface of each of the liquid crystal panels 18. The maximum object height is expressed in mm. The brightness is expressed in the form of NA. The mirror radius is the radius of the mirror M in millimeters. The final lens radius is the radius of the lens L17 of the third optical system 33 in millimeters. The overall lens length of the projection system 3A is the distance in millimeters from the lens L1 to the mirror M along the axis Z of the first optical system 31. TR stands for a throw ratio that is the quotient of the dimension of the screen S in the axis-X direction and the projection distance, specifically, the former divided by the latter.

| | |
|---|---|
| Maximum object height | 11.7 |
| NA | 0.3125 |
| Mirror radius | 42.1 |
| Final lens radius | 40.5 |
| Overall lens length | 273 |
| TR (0.59□WXGA) | 0.29 |

### Effects and Advantages

The projection system 3A according to the present example is formed of the first optical system 31, the second optical system 32, and the third optical system 33 sequentially arranged from the reduction side toward the enlargement side. The first optical system 31 includes the lens L16 disposed in a position closest to the enlargement side and forms the intermediate image 35, which is conjugate with the reduction-side image formation plane, between the first optical system 31 and the second optical system 32. The second optical system 32 includes the mirror M formed of a concave curved surface. The third optical system 33 includes the lens L17 disposed in a position closest to the enlargement side and having negative power. The effective range of the lens L16 is located at the lower side Y2 of the optical axis N of the first optical system 31, and the effective range of the lens L17 is located at the upper side Y1 of the optical axis N.

That is, the projection system 3A according to the present example includes the third optical system 33, which has negative power, at the enlargement side of the mirror M. The lens L17 of the third optical system 33 has negative power. The lens L17 can therefore project the light rays outputted from the mirror M having the concave curved surface toward the enlargement side on the screen S with the light rays inclining with respect to the screen S. The projection distance of the projection system 3A can thus be shortened.

Further, according to the present example, light ray tracing from the screen S shows that the effect provided by the lens L17 reduces the angles of the light rays traveling toward the mirror M. When the light rays are traced from the screen S and the angles of the rays with respect to the mirror M decrease, the position where the light ray that reaches the upper portion of the screen S forms the intermediate image 35 and the position where the light ray that reaches the lower portion of the screen S forms the intermediate image 35 approach each other along the axis Z of the first optical system 31. The intermediate image 35 is therefore erected in the direction perpendicular to the optical axis N of the first optical system 31 and decreases in size in the axis-Z direction. The size of the mirror M, which captures the light flux divergent in the segment from the position where the intermediate image 35 is formed toward the enlargement side, can therefore be reduced. Further, since the size of the intermediate image 35 decreases in the axis-Z direction, the first optical system 31 and the second optical system 32 are allowed to approach each other in the axis-Z direction. The overall lens length can therefore be shortened.

Further, in the present example, the optical element O, which is disposed at the opposite side of the second optical system 32 with respect to the intermediate image 35 along the optical axis N of the first optical system 31, is provided. The lens L16, which is the final lens of the first optical system 31, is the first optical element section O1 of the optical element O, which is the section at the lower side Y2 of the optical axis N of the first optical system 31, and the lens L17, which forms the third optical system 33, is the second optical element section O2 of the optical element O, which is the section at the upper side Y1 of the optical axis N of the first optical system 31. The number of lenses that form the projection system 3A can thus be suppressed.

The lens L17 of the third optical system 33 has a meniscus shape. That is, the reduction-side surface of the lens L17 has a concave curved shape recessed toward the enlargement side, and the enlargement-side surface of the lens L17 has a convex curved shape protruding toward the enlargement side. The thickness of the lens L17 increases with distance from the optical axis N of the first optical system 31 toward the upper side Y1. In other words, the light rays reflected off the mirror M and passing through the lens L17 each travel along an optical path length in the lens L17 that increases with distance from the optical axis N of the first optical system 31 toward the upper side Y1. The negative power of the third optical system 33 can therefore be increased, whereby the projection distance of the projection system 3A can be readily shortened.

In the projection system 3A, an area A, where the optical density is maximized in the optical path from the reduction-side image formation plane to the enlargement-side image formation plane conjugate with the intermediate image 35, is located between the second optical system 32 and the third optical system 33. That is, the area A, where the optical density is maximized, is located outside the optical elements that form the projection system 3A, such as the lenses. Therefore, in the projection system 3A, a situation in which the optical elements are heated so that the optical characteristics thereof change can be avoided or suppressed.

In the present example, the lens L17 of the third optical system 33 has an aspheric surface at the reduction side. Further, in the present example, the lens L17 has an aspheric surface also at the enlargement side. Occurrence of distortion is therefore readily suppressed.

Further, since the third optical system 33 is formed of one lens, the number of lenses that form the projection system 3A is readily suppressed. The third optical system 33 may further include a lens at the enlargement side of the lens L17.

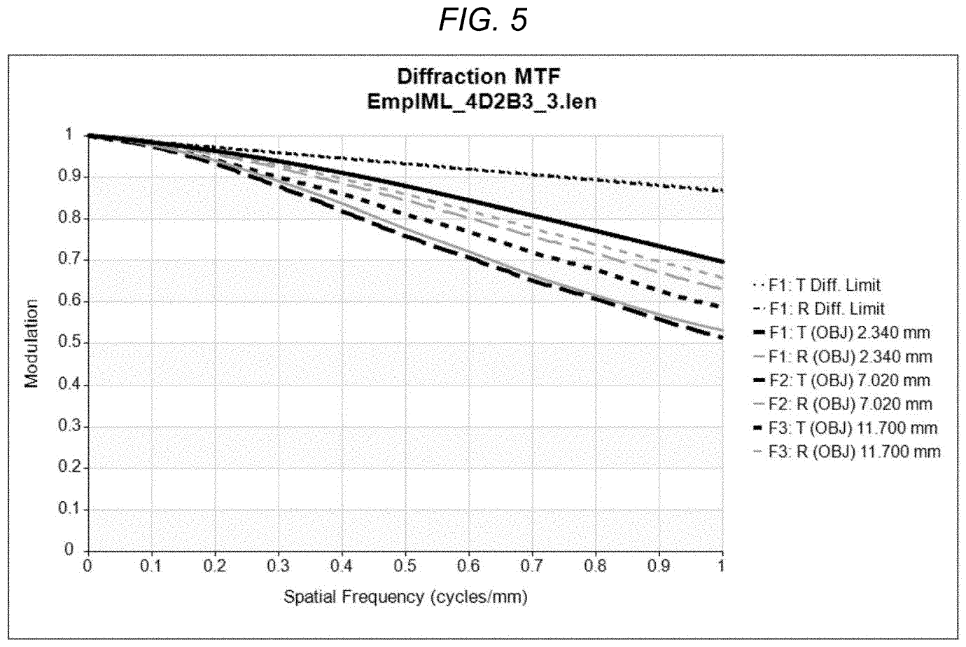

FIG. 5 shows the enlargement-side MTF of the projection system 3A. The horizontal axis of FIG. 5, which shows the MTF, represents the spatial frequency. The vertical axis of FIG. 5 represents a contrast reproduction ratio (modulation). In FIG. 5, the black graphs represent tangential light rays (T), and the gray graphs represent radial light rays (R). Out of the tangential light rays (T) and the radial light rays (R), the solid lines represent the light flux F1, the long-line-segment broken lines represent the light flux F2, and the broken lines represent the light flux F3. The projection system 3A according to the present example provides high resolution, as shown in FIG. 5.

### Example 2

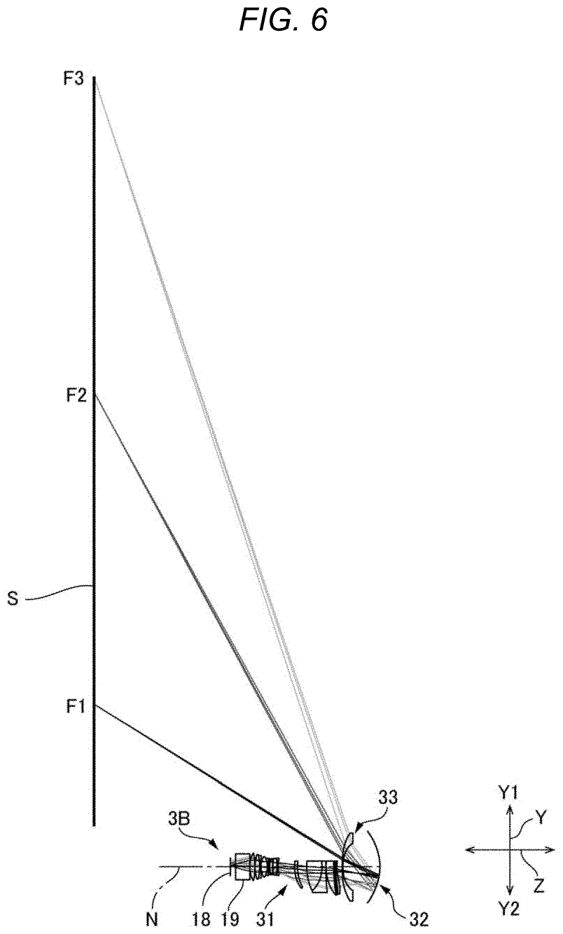

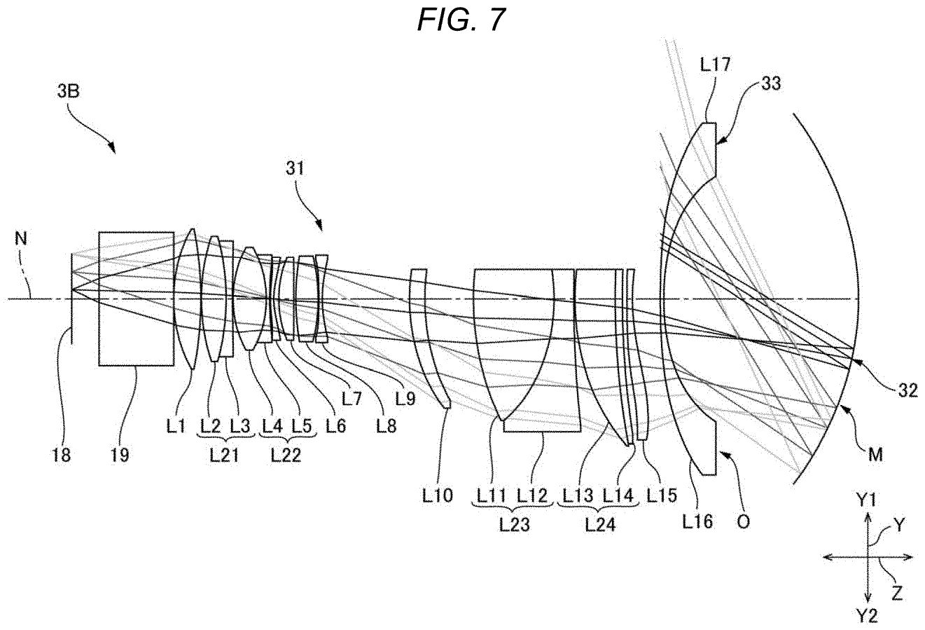

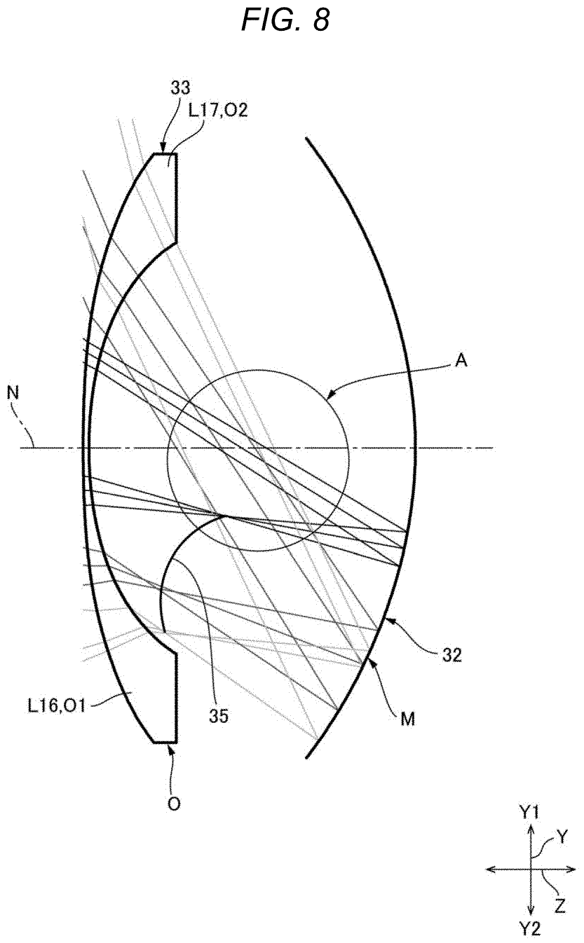

FIG. 6 is a light ray diagram diagrammatically showing the entire projection system according to Example 2. FIG. 6 diagrammatically shows light fluxes that exit out of a projection system 3B according to the present example and reach the screen S in the form of the light fluxes F1 to F3. FIG. 7 is a light ray diagram of the light rays passing through the projection system according to Example 2. FIG. 8 is a light ray diagram of the light rays passing through the lens located in a position closest to the enlargement side in a first optical system, a second optical system, and a third optical system. The projection system 3B according to Example 2 has a configuration corresponding to that of the projection system 3A described above, and corresponding components therefore have the same reference characters in the description.

The projection system 3B according to the present example is formed of the first optical system 31, the second optical system 32, and the third optical system 33 sequentially arranged from the reduction side toward the enlargement side, as shown in FIG. 7. The first optical system 31 is a refractive optical system including a plurality of lenses. The second optical system 32 includes the mirror M having a concave curved surface. The third optical system 33 has negative power. The first optical system 31 forms the intermediate image 35, which is conjugate with the reduction-side image formation plane, between the first optical system 31 and the second optical system 32, as shown in FIG. 8. The second optical system 32 and the third optical system 33 form a final image conjugate with the intermediate image 35 in the enlargement-side image formation plane. The liquid crystal panels 18 located in the reduction-side image formation plane form projection images at the upper side Y1 of the optical axis N. The intermediate image 35 is formed at the lower side Y2 of the optical axis N. The screen S disposed in the enlargement-side image formation plane is located at the upper side Y1 of the optical axis N. The lateral direction of the screen S coincides with the axis-X direction. The intermediate image 35 is the image formed on the screen S that is not enlarged but turned upside down in the axis-Y direction. FIGS. 6, 7, and 8 are light ray diagrams in the plane YZ.

The first optical system 31 includes the cross dichroic prism 19 and 16 lenses L1 to L16, as shown in FIG. 7. The lenses L1 to L16 are arranged in the presented order from the reduction side toward the enlargement side. In the present example, the lenses L2 and L3 are bonded to each other to form the first doublet L21. The lenses L4 and L5 are bonded to each other to form the second doublet L22. The lenses L11 and L12 are bonded to each other to form the third doublet L23. The lenses L13 and L14 are bonded to each other to form the fourth doublet L24. The light flux passage area of the lens L16 (first lens) is located at the lower side Y2 of the optical axis N.

The second optical system 32 is formed of one mirror M, as shown in FIG. 8. The mirror M reflects the light rays from the first optical system 31 toward the upper side Y1.

The third optical system 33 is formed of one lens L17 (second lens) having a meniscus shape. The lens L17 is disposed at the upper side Y1 of the optical axis N of the first optical system 31. The reduction-side surface of the lens L17 has a concave curved surface recessed toward the enlargement side. The reduction-side surface of the lens L17 has negative power. The reduction-side surface of the lens L17 is an aspheric surface. The enlargement-side surface of the lens L17 is a convex curved surface protruding toward the enlargement side. The enlargement-side surface of the lens L17 is an aspheric surface. The thickness of the lens L17 increases with distance from the optical axis N of the first optical system 31 toward the upper side Y1.

In the projection system 3B, the area A, where the optical density is maximized in the optical path from the reduction-side image formation plane to the enlargement-side image formation plane, is located between the second optical system 32 and the third optical system 33.

The lens L16 of the first optical system 31 and the lens L17 of the third optical system 33 are each provided as part of one optical element O, which is disposed at the opposite side of the second optical system 32 with respect to the intermediate image 35 along the optical axis N of the first optical system 31. That is, the lens L16 of the first optical system 31 is the first optical element section O1 of the optical element O, which is the section at the lower side Y2 of the optical axis N of the first optical system 31. The lens L17 of the third optical system 33 is the second optical element section O2 of the optical element O, which is the section at the upper side Y1 of the optical axis N of the first optical system 31.

### Lens Data

Data on the lenses of the projection system 3B are as follows: The surfaces of the lenses are numbered sequentially from the reduction side toward the enlargement side. Reference characters are given to the lenses and the mirror. Reference character R denotes the radius of curvature of a lens surface or a mirror surface. Reference character D denotes the on-axis distance between surfaces. Reference character C denotes the effective diameter of a lens surface or a mirror surface. Reference characters R, D, and C are each expressed in millimeters.

| Reference | Surface | | | | Glass | Refraction/ | |
|---|---|---|---|---|---|---|---|
| character | number | Shape | R | D | material | reflection | C |
| | 0 | Spherical | Infinity | 0.0000 | | Refraction | 0.0000 |
| | 1 | Spherical | Infinity | 9.5000 | | Refraction | 11.7000 |
| 19 | 2 | Spherical | Infinity | 25.9100 | SBSL7 | Refraction | 13.3182 |
| | 3 | Spherical | Infinity | 0.0000 | | Refraction | 16.2020 |
| L1 | 4 | Spherical | 30.3278 | 9.3259 | SFPL51 | Refraction | 17.1016 |
| | 5 | Spherical | −71.8493 | 0.2021 | | Refraction | 16.8620 |
| L2 | 6 | Spherical | 39.9699 | 8.5691 | SFSL5 | Refraction | 15.1975 |
| L3 | 7 | Spherical | −46.9494 | 2.2341 | STIH6 | Refraction | 14.0000 |
| | 8 | Spherical | 396.1335 | 0.2000 | | Refraction | 13.2961 |
| L4 | 9 | Spherical | 22.2287 | 11.5106 | SBSL7 | Refraction | 12.3480 |
| L5 | 10 | Spherical | −21.5648 | 1.2000 | TAFD25 | Refraction | 10.4773 |
| | 11 | Spherical | 67.9160 | 0.2000 | | Refraction | 9.8627 |
| L6 | 12 | Aspheric | 20.2614 | 1.1997 | LBAL35 | Refraction | 9.8479 |
| | | surface | | | | | |
| | 13 | Aspheric | 13.0461 | 1.7539 | | Refraction | 9.7302 |
| | | surface | | | | | |
| L7 | 14 | Spherical | 21.8096 | 5.2270 | SFSL5 | Refraction | 9.8583 |
| | 15 | Spherical | −811.2166 | 0.2000 | | Refraction | 9.5143 |
| | 16 | Spherical | Infinity | 0.4916 | | Refraction | 9.4658 |
| L8 | 17 | Spherical | 50.2350 | 7.7354 | STIH53 | Refraction | 9.9074 |
| | 18 | Spherical | −35.2992 | 0.2182 | | Refraction | 10.2091 |
| L9 | 19 | Aspheric | −229.6415 | 1.2070 | LLAM60 | Refraction | 10.1014 |
| | | surface | | | | | |
| | 20 | Aspheric | 23.3953 | 7.1747 | | Refraction | 10.4338 |
| | | surface | | | | | |
| | 21 | Spherical | Infinity | 23.1237 | | Refraction | 12.6074 |
| L10 | 22 | Spherical | 39.8368 | 5.3358 | STIM22 | Refraction | 27.0000 |
| | 23 | Spherical | 44.3376 | 16.8499 | | Refraction | 26.4932 |
| L11 | 24 | Spherical | 57.3488 | 27.9599 | STIM2 | Refraction | 31.3567 |
| L12 | 25 | Spherical | −37.6257 | 6.8632 | STIH6 | Refraction | 31.1522 |
| | 26 | Spherical | 231.9361 | 0.4054 | | Refraction | 32.9394 |
| L13 | 27 | Spherical | 49.7771 | 13.9592 | STIL25 | Refraction | 36.4799 |
| L14 | 28 | Spherical | 159.8387 | 2.5053 | STIH6 | Refraction | 35.9645 |
| | 29 | Spherical | 176.9307 | 1.5704 | | Refraction | 35.4864 |
| L15 | 30 | Aspheric | 387.5955 | 1.9078 | □Z-E48R□ | Refraction | 35.0667 |
| | | surface | | | | | |
| | 31 | Aspheric | 41.7328 | 9.6693 | | Refraction | 34.4983 |
| | | surface | | | | | |
| L16 | 32 | Aspheric | 176.3833 | 1.2000 | □Z-E48R□ | Refraction | 31.5775 |
| | | surface | | | | | |
| | 33 | Aspheric | 48.6716 | 67.6000 | | Refraction | 28.5952 |
| | | surface | | | | | |
| M | 34 | Aspheric | −52.0669 | −67.6000 | | Reflection | 46.2470 |
| | | surface | | | | | |
| | 35 | Spherical | Infinity | 0.0000 | | Refraction | 60.7706 |
| L17 | 36 | Aspheric | 48.6716 | −1.2000 | □Z-E48R□ | Refraction | 32.0583 |
| | | surface | | | | | |
| | 37 | Aspheric | 176.3833 | 0.0000 | | Refraction | 43.8508 |
| | | surface | | | | | |
| | 38 | Spherical | Infinity | −433.4000 | | Refraction | 81.8472 |
| | 39 | Spherical | Infinity | 0.0000 | | | 1382.1140 |

The aspheric constants of each of the aspheric surfaces are listed below.

| Surface number | S12 | S13 | S19 | S20 |
|---|---|---|---|---|
| Radius of | 20.26140547 | 13.0461295 | −229.6414599 | 23.39527788 |
| curvature in | | | | |
| axis-Y direction | | | | |
| Conic constant | 1.568 | −1.3 | −1 | −0.88 |
| (K) | | | | |
| Fourth-order | −3.45427E−04 | −2.79879E−04 | −6.71631E−05 | −4.16610E−05 |
| coefficient (A) | | | | |
| Sixth-order | 1.60875E−06 | 2.03668E−06 | −1.00842E−07 | −9.53264E−10 |
| coefficient (B) | | | | |
| Eighth-order | −5.30496E−09 | −9.51880E−09 | −7.34814E−11 | 3.07082E−10 |
| coefficient (C) | | | | |
| Tenth-order | −5.50717E−12 | 1.66637E−11 | | |
| coefficient (D) | | | | |

| Surface number | S30 | S31 | S32 | S33 |
|---|---|---|---|---|
| Radius of | 387.5955126 | 41.73282202 | 176.3832591 | 48.67161757 |
| curvature in | | | | |
| axis-Y direction | | | | |
| Conic constant | 90 | 0 | 11.80225283 | 1.094322819 |
| (K) | | | | |
| Fourth-order | 1.01203E−05 | −1.17185E−05 | 2.87209E−06 | 1.36690E−06 |
| coefficient (A) | | | | |
| Sixth-order | −1.40448E−08 | 1.19637E−08 | −1.14555E−09 | 3.14586E−09 |
| coefficient (B) | | | | |
| Eighth-order | 1.42478E−11 | −1.66915E−11 | 1.98416E−13 | −2.66990E−12 |
| coefficient (C) | | | | |
| Tenth-order | −1.86681E−14 | 5.93763E−15 | | |
| coefficient (D) | | | | |
| Twelfth-order | 1.42953E−17 | 3.89540E−18 | | |
| coefficient (E) | | | | |

| Surface number | S34 | S36 | S37 |
|---|---|---|---|
| Radius of | −52.06688058 | 48.67161757 | 176.3832591 |
| curvature in | | | |
| axis-Y direction | | | |
| Conic constant | −1 | 1.094322819 | 11.80225283 |
| (K) | | | |
| Fourth-order | 4.53933E−07 | 1.36690E−06 | 2.87209E−06 |
| coefficient (A) | | | |
| Sixth-order | −3.53577E−10 | 3.14586E−09 | −1.14555E−09 |
| coefficient (B) | | | |
| Eighth-order | 1.14681E−13 | −2.66990E−12 | 1.98416E−13 |
| coefficient (C) | | | |
| Tenth-order | −2.76345E−17 | | |
| coefficient (D) | | | |
| Twelfth-order | 2.22920E−21 | | |
| coefficient (E) | | | |

The maximum object height, the brightness, the mirror radius, the final lens radius, the lens overall length, and TR of the projection system 3B are as follows:

| | |
|---|---|
| Maximum object height | 11.7 |
| NA | 0.3125 |
| Mirror radius | 46.3 |
| Final lens radius | 43.9 |
| Overall lens length | 273 |
| TR (0.59□WXGA) | 0.29 |

### Effects and Advantages

The projection system 3B according to the present example can provide the same effects and advantages as those provided by the projection system 3A described above.

In the projection system 3B according to the present example, the lens L16 of the first optical system 31 and the lens L17 of the third optical system 33 are so shaped as to correspond to each other, as shown in the lens data. That is, the surface number 32, which represents the reduction-side lens surface of the lens L16 of the first optical system 31 and the surface number 37, which represents the enlargement-side lens surface of the lens L17 of the third optical system 33 represent shapes corresponding to each other. Further, the surface number 33, which represents the enlargement-side lens surface of the lens L16 of the first optical system 31 and the surface number 36, which represents the reduction-side lens surface of the lens L17 of the third optical system 33 represent shapes corresponding to each other.

Therefore, the optical element O, which is a meniscus lens, can be formed of the lens L16, which is the first optical element section O1 at the lower side Y2 of the optical axis N, and the lens L17, which is the second optical element section O2 at the upper side Y1 of the optical axis N. In other words, disposing one meniscus lens allows the lens L16 of the first optical system 31 and the lens L17 of the third optical system 33 to be provided. Further, to manufacture one meniscus lens as the optical element O, manufacturing an optical element formed of a portion located at the upper side Y1 of the axis N and a portion located at the lower side Y2 of the axis N and having a shape corresponding to that of the portion at the upper side Y1 is more productive than manufacturing an optical element formed of a portion located at the upper side Y1 of the axis N and a portion located at the lower side Y2 of the axis N and having a shape different from that of the portion at the upper side Y1, whereby a decrease in yield can be suppressed. The projection system 3B is readily produced in large quantities.

Further, in the present example, since the lens L16 of the first optical system 31 and the lens L17 of the third optical system 33 have shapes corresponding to each other, the lens L16 has negative power as the lens L17. When the lens L16 of the first optical system 31 has negative power, the lens L16 can assist the power of the mirror M having a concave curved surface. The size of the mirror M along the optical axis N can thus be reduced.

The third optical system 33 may further include a lens at the enlargement side of the lens L17.

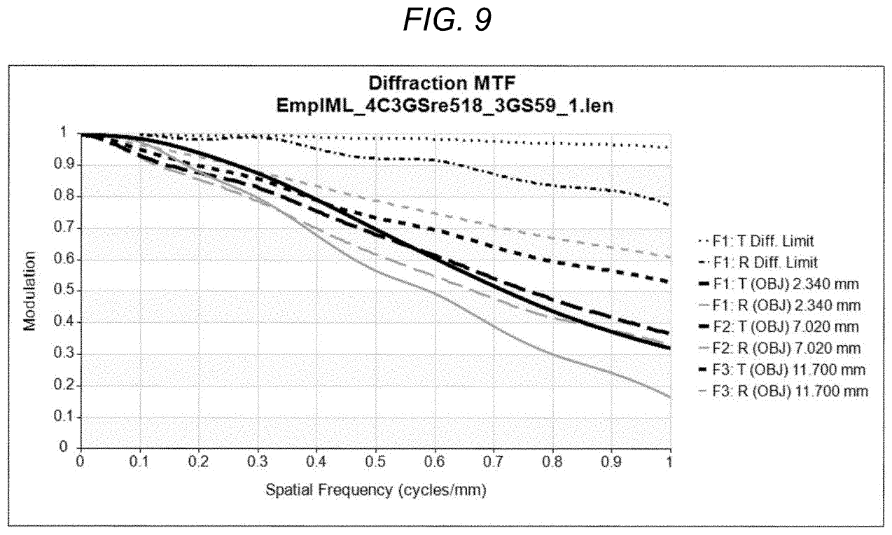

FIG. 9 shows the enlargement-side MTF of the projection system 3B. The projection system 3B according to the present example provides high resolution, as shown in FIG. 9.

### Example 3

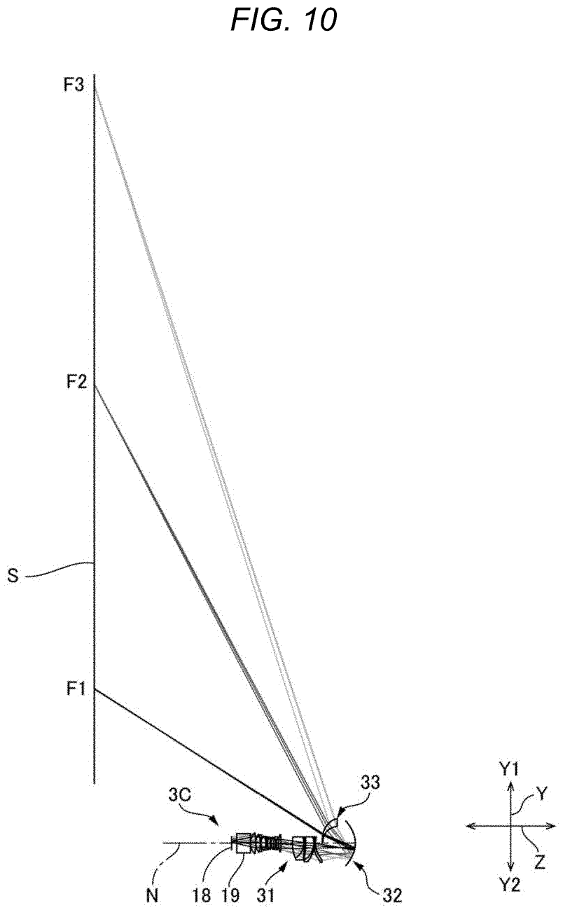

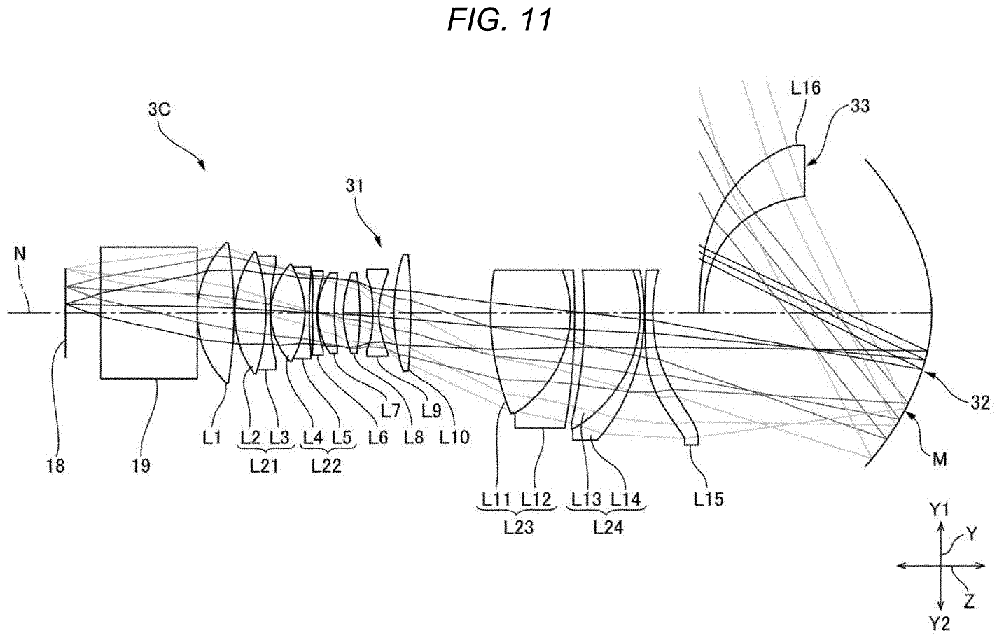

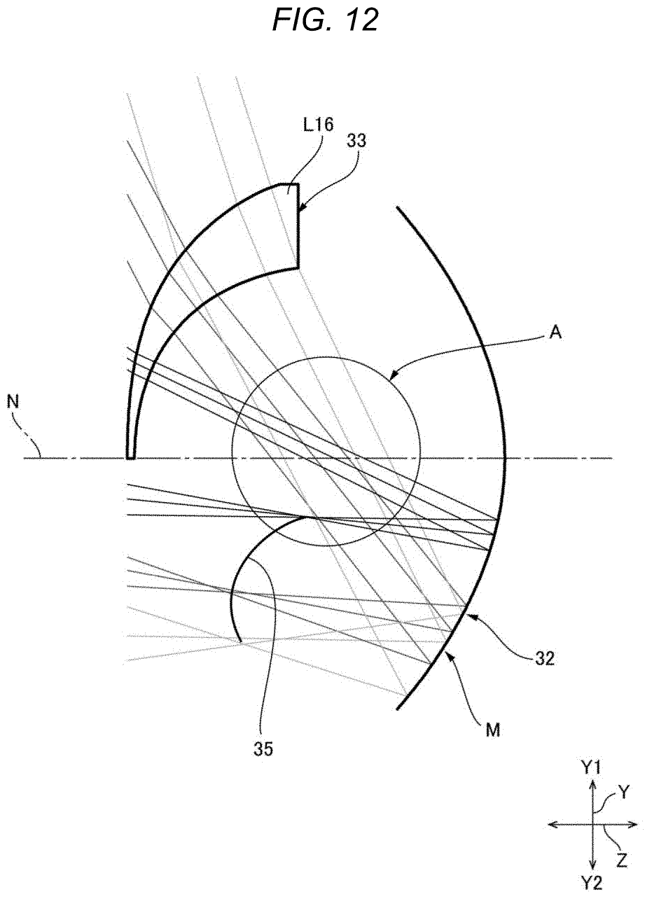

FIG. 10 is a light ray diagram diagrammatically showing the entire projection system according to Example 3. FIG. 10 diagrammatically shows light fluxes that exit out of a projection system 3C according to the present example and reach the screen S in the form of the light fluxes F1 to F3. FIG. 11 is a light ray diagram of the light rays passing through the projection system according to Example 3. FIG. 12 is a light ray diagram in the vicinity of the second optical system and the third optical system. The projection system 3C according to Example 3 has a configuration corresponding to that of the projection system 3A described above, and corresponding components therefore have the same reference characters in the description.

The projection system 3C according to the present example is formed of the first optical system 31, the second optical system 32, and the third optical system 33 sequentially arranged from the reduction side toward the enlargement side, as shown in FIG. 11. The first optical system 31 is a refractive optical system including a plurality of lenses. The second optical system 32 includes the mirror M having a concave curved surface. The third optical system 33 has negative power. The first optical system 31 forms the intermediate image 35, which is conjugate with the reduction-side image formation plane, between the first optical system 31 and the second optical system 32, as shown in FIG. 12. The second optical system 32 and the third optical system 33 form a final image conjugate with the intermediate image 35 in the enlargement-side image formation plane. The liquid crystal panels 18 located in the reduction-side image formation plane form projection images at the upper side Y1 of the optical axis N. The intermediate image 35 is formed at the lower side Y2 of the optical axis N. The screen S disposed in the enlargement-side image formation plane is located at the upper side Y1 of the optical axis N. The lateral direction of the screen S coincides with the axis-X direction. The intermediate image 35 is the image formed on the screen S that is not enlarged but turned upside down in the axis-Y direction. FIGS. 10, 11, and 12 are light ray diagrams in the plane YZ.

The first optical system 31 includes the cross dichroic prisms 19 and 15 lenses L1 to L15, as shown in FIG. 11. The lenses L1 to L15 are arranged in the presented order from the reduction side toward the enlargement side. In the present example, the lenses L2 and L3 are bonded to each other to form the first doublet L21. The lenses L4 and L5 are bonded to each other to form the second doublet L22. The lenses L11 and L12 are bonded to each other to form the third doublet L23. The lenses L13 and L14 are bonded to each other to form the fourth doublet L24. The light flux passage area of the lens L15 (first lens) is located at the lower side Y2 of the optical axis N.

The second optical system 32 is formed of one mirror M, as shown in FIG. 12. The mirror M reflects the light rays from the first optical system 31 toward the upper side Y1.

The third optical system 33 is formed of one lens L16 (second lens) having a meniscus shape. The lens L16 is disposed at the upper side Y1 of the optical axis N of the first optical system 31. The reduction-side surface of the lens L16 has a concave curved surface recessed toward the enlargement side. The reduction-side surface of the lens L16 has negative power. The reduction-side surface of the lens L16 is an aspheric surface. The enlargement-side surface of the lens L16 is a convex curved surface protruding toward the enlargement side. The enlargement-side surface of the lens L16 is an aspheric surface. The thickness of the lens L16 increases with distance from the optical axis N of the first optical system 31 toward the upper side Y1.

In the projection system 3C, the area A, where the optical density is maximized in the optical path from the reduction-side image formation plane to the enlargement-side image formation plane, is located between the second optical system 32 and the third optical system 33.

The lens L16 of the third optical system 33 is disposed in a position closer to the mirror M than the lens L15, which is located in the optical axis N of the first optical system 31 and in a position closest to the enlargement side in the first optical system 31.

### Lens Data

Data on the lenses of the projection system 3C are as follows: The surfaces of the lenses are numbered sequentially from the reduction side toward the enlargement side. Reference characters are given to the lenses and the mirror. Reference character R denotes the radius of curvature of a lens surface or a mirror surface. Reference character D denotes the on-axis distance between surfaces. Reference character C denotes the effective diameter of a lens surface or a mirror surface. Reference characters R, D, and C are each expressed in millimeters.

| Reference | Surface | | | | Glass | Refraction/ | |
|---|---|---|---|---|---|---|---|
| character | number | Shape | R | D | material | reflection | C |
| | 0 | Spherical | Infinity | 0.0000 | | Refraction | 0.0000 |
| | 1 | Spherical | Infinity | 9.5000 | | Refraction | 11.7000 |
| 19 | 2 | Spherical | Infinity | 25.9100 | SBSL7 | Refraction | 13.3445 |
| | 3 | Spherical | Infinity | 0.0000 | | Refraction | 16.2743 |
| L1 | 4 | Spherical | 26.2870 | 9.8874 | SFPL51 | Refraction | 17.4163 |
| | 5 | Spherical | −114.0876 | 0.2000 | | Refraction | 17.0589 |
| L2 | 6 | Spherical | 27.4668 | 8.3488 | SFSL5 | Refraction | 14.9069 |
| L3 | 7 | Spherical | −51.3244 | 1.2000 | STIH6 | Refraction | 14.0000 |
| | 8 | Spherical | 54.6395 | 0.2098 | | Refraction | 12.8227 |
| L4 | 9 | Spherical | 18.5782 | 9.0874 | SBSL7 | Refraction | 12.0166 |
| L5 | 10 | Spherical | −24.5458 | 1.2000 | TAFD25 | Refraction | 11.1356 |
| | 11 | Spherical | 109.7598 | 0.8616 | | Refraction | 10.2913 |
| L6 | 12 | Aspheric | 53.3422 | 1.2000 | LBAL35 | Refraction | 10.1819 |
| | | surface | | | | | |
| | 13 | Aspheric | 22.4913 | 0.2000 | | Refraction | 9.7741 |
| | | surface | | | | | |
| L7 | 14 | Spherical | 18.5235 | 4.4908 | SFSL5 | Refraction | 9.7606 |
| | 15 | Spherical | 53.5909 | 2.3051 | | Refraction | 9.2518 |
| | 16 | Spherical | Infinity | 0.2000 | | Refraction | 8.9283 |
| L8 | 17 | Spherical | 28.6412 | 4.3711 | STIH53 | Refraction | 9.7128 |
| | 18 | Spherical | −71.1586 | 3.4903 | | Refraction | 9.7637 |
| L9 | 19 | Aspheric | −59.2915 | 1.6422 | LLAM60 | Refraction | 9.5779 |
| | | surface | | | | | |
| | 20 | Aspheric | 19.8927 | 3.8576 | | Refraction | 10.5554 |
| | | surface | | | | | |
| | 21 | Spherical | Infinity | 0.2000 | | Refraction | 11.9089 |
| L10 | 22 | Spherical | 50.3317 | 4.5209 | STIM22 | Refraction | 13.8391 |
| | 23 | Spherical | −178.2940 | 21.5104 | | Refraction | 14.3728 |
| L11 | 24 | Spherical | 68.4656 | 21.3878 | STIM2 | Refraction | 26.0000 |
| L12 | 25 | Spherical | −31.1606 | 1.2000 | STIH6 | Refraction | 26.1591 |
| | 26 | Spherical | −177.1291 | 2.5593 | | Refraction | 28.8624 |
| L13 | 27 | Spherical | −126.3867 | 15.0000 | STIL25 | Refraction | 29.2250 |
| L14 | 28 | Spherical | −35.1022 | 1.2000 | STIH6 | Refraction | 29.7095 |
| | 29 | Spherical | −51.0664 | 0.2000 | | Refraction | 32.0278 |
| L15 | 30 | Aspheric | −1865.5094 | 2.0076 | □Z-E48R□ | Refraction | 33.3264 |
| | | surface | | | | | |
| | 31 | Aspheric | 42.5160 | 13.7457 | | Refraction | 32.8148 |
| | | surface | | | | | |
| | 32 | Spherical | Infinity | 0.0000 | | Refraction | 32.6126 |
| | 33 | Spherical | Infinity | 61.3064 | | Refraction | 32.6126 |
| M | 34 | Aspheric | −44.3062 | −61.3064 | | Reflection | 38.8304 |
| | | surface | | | | | |
| | 35 | Spherical | Infinity | 0.0000 | | Refraction | 86.7508 |
| L16 | 36 | Aspheric | 42.0853 | −1.2000 | □Z-E48R□ | Refraction | 30.9008 |
| | | surface | | | | | |
| | 37 | Aspheric | 118.6751 | 0.0000 | | Refraction | 43.9961 |
| | | surface | | | | | |
| | 38 | Spherical | Infinity | −439.6936 | | Refraction | 117.1750 |
| | 39 | Spherical | Infinity | 0.0000 | | Refraction | 1469.8039 |

The aspheric constants of each of the aspheric surfaces are listed below.

| Surface number | S12 | S13 | S19 | S20 |
|---|---|---|---|---|
| Radius of | 53.34221761 | 22.49128344 | −59.29150676 | 19.89273998 |
| curvature in | | | | |
| axis-Y direction | | | | |
| Conic constant | 1.568 | −1.3 | −1 | −0.88 |
| (K) | | | | |
| Fourth-order | −1.93783E−04 | −1.35859E−04 | −8.56185E−05 | −4.35212E−05 |
| coefficient (A) | | | | |
| Sixth-order | 1.56223E−06 | 1.61810E−06 | −6.83468E−08 | 5.26818E−08 |
| coefficient (B) | | | | |
| Eighth-order | −7.06670E−09 | −8.84670E−09 | −3.55359E−10 | −5.98134E−13 |
| coefficient (C) | | | | |
| Tenth-order | 1.36669E−11 | 1.88865E−11 | | |
| coefficient (D) | | | | |

| Surface number | S30 | S31 |
|---|---|---|
| Radius of | 1865.509356 | 42.51598454 |
| curvature in | | |
| axis-Y direction | | |
| Conic constant | 90 | 0 |
| (K) | | |
| Fourth-order | 2.07327E−05 | −1.60331E−06 |
| coefficient (A) | | |
| Sixth-order | −1.64003E−08 | 1.39989E−08 |
| coefficient (B) | | |
| Eighth-order | 1.19436E−11 | −2.06433E−11 |
| coefficient (C) | | |
| Tenth-order | −1.12644E−14 | 4.23072E−15 |
| coefficient (D) | | |
| Twelfth-order | 6.86665E−18 | 3.30023E−18 |
| coefficient (E) | | |
| Fourteenth-order | −2.02644E−21 | −1.41483E−21 |
| coefficient (F) | | |

| Surface number | S34 | S36 | S37 |
|---|---|---|---|
| Radius of | −44.30622587 | 42.08529774 | 118.6750917 |
| curvature in | | | |
| axis-Y direction | | | |
| Conic constant | −1 | 0.838596842 | 5.9457377 |
| (K) | | | |
| Fourth-order | 1.02038E−06 | 5.01374E−06 | 3.63707E−06 |
| coefficient (A) | | | |
| Sixth-order | −6.59907E−10 | −2.50762E−09 | −8.15678E−10 |
| coefficient (B) | | | |
| Eighth-order | 1.58870E−13 | 4.76676E−12 | 1.88373E−13 |
| coefficient (C) | | | |
| Tenth-order | 5.15051E−17 | | |
| coefficient (D) | | | |
| Twelfth-order | −5.66805E−20 | | |
| coefficient (E) | | | |
| Fourteenth-order | 1.33892E−23 | | |
| coefficient (F) | | | |

The maximum object height, the brightness, the mirror radius, the final lens radius, the lens overall length, and TR of the projection system 3C are as follows:

| | |
|---|---|
| Maximum object height | 11.7 |
| NA | 0.3125 |
| Mirror radius | 38.8 |
| Final lens radius | 44.0 |
| Overall lens length | 233 |
| TR (0.59□WXGA) | 0.27 |

### Effects and Advantages

In the projection system 3C according to the present example, the lens L16, which is disposed in a position closest to the enlargement side in the first optical system 31, and the lens L17, which forms the third optical system 33, cannot be so provided as to form one optical element. The projection system 3C according to the present example, however, can provide the same effects and advantages as those provided by the projection system 3A described above except the aforementioned effect and advantage of one optical element containing the lenses L16 and L17.

In the present example, the lens L15, which is located in a position closest to the enlargement side in the first optical system 31, has positive power. The divergence of the light flux that exits out of the first optical system and enters the second optical system 32 can thus be suppressed, whereby the size of the mirror M can be readily reduced.

The third optical system 33 may further include a lens at the enlargement side of the lens L16.

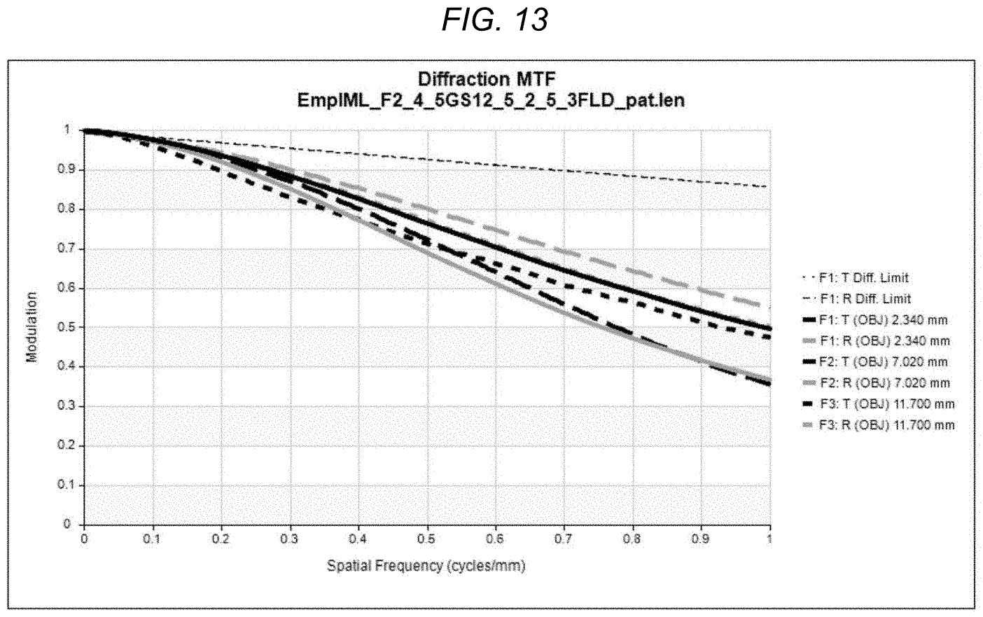

FIG. 13 shows the enlargement-side MTF of the projection system 3C. The projection system 3C according to the present example provides high resolution, as shown in FIG. 13.

### Example 4

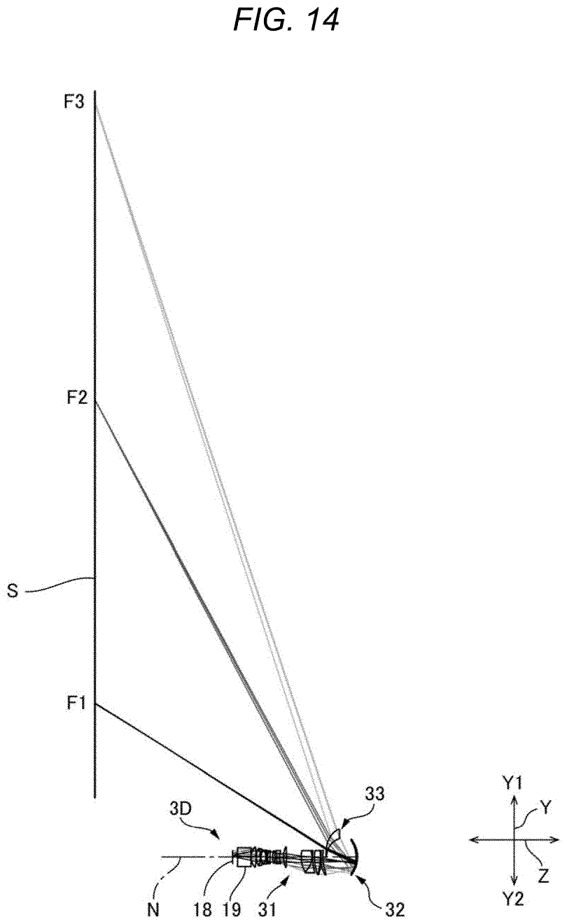

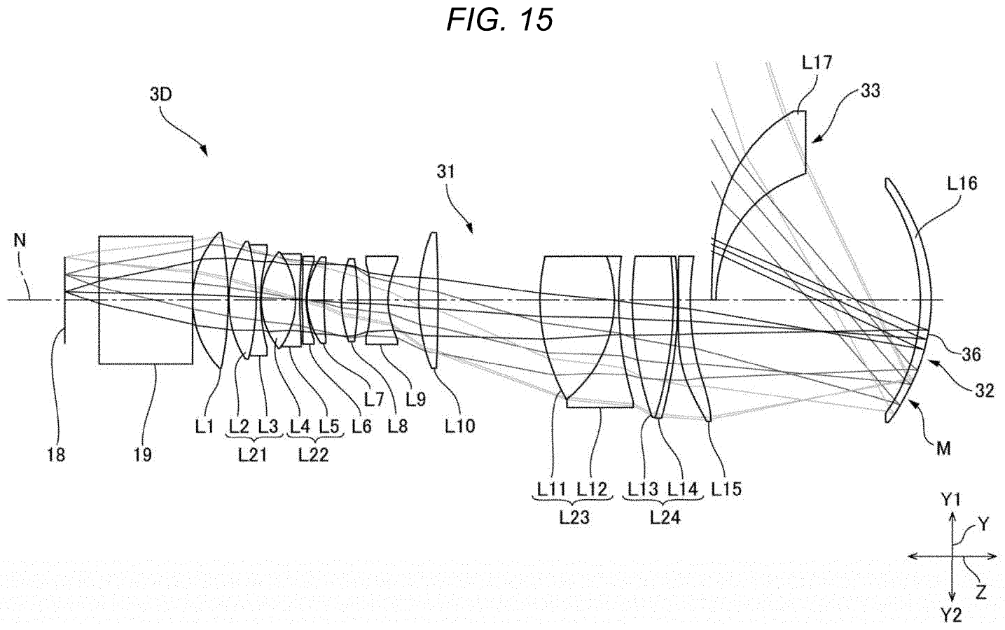

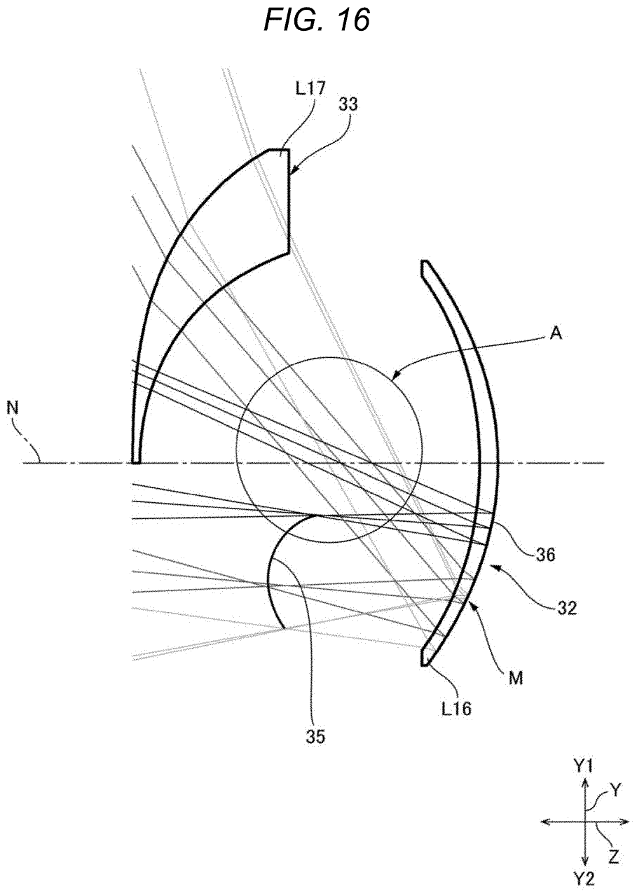

FIG. 14 is a light ray diagram diagrammatically showing the entire projection system according to Example 4. FIG. 14 diagrammatically shows light fluxes that exit out of a projection system 3D according to the present example and reach the screen S in the form of the light fluxes F1 to F3. FIG. 15 is a light ray diagram of the light rays passing through the projection system according to Example 4. FIG. 16 is a light ray diagram in the vicinity of the second optical system and the third optical system. The projection system 3D according to Example 4 has a configuration corresponding to that of the projection system 3A described above, and corresponding components therefore have the same reference characters in the description.

The projection system 3D according to the present example is formed of the first optical system 31, the second optical system 32, and the third optical system 33 sequentially arranged from the reduction side toward the enlargement side, as shown in FIG. 15. The first optical system 31 is a refractive optical system including a plurality of lenses. The second optical system 32 includes the mirror M having a concave curved surface. The third optical system 33 has negative power. The first optical system 31 forms the intermediate image 35, which is conjugate with the reduction-side image formation plane, between the first optical system 31 and the second optical system 32, as shown in FIG. 16. The second optical system 32 and the third optical system 33 form a final image conjugate with the intermediate image 35 in the enlargement-side image formation plane. The liquid crystal panels 18 located in the reduction-side image formation plane form projection images at the upper side Y1 of the optical axis N. The intermediate image 35 is formed at the lower side Y2 of the optical axis N. The screen S disposed in the enlargement-side image formation plane is located at the upper side Y1 of the optical axis N. The lateral direction of the screen S coincides with the axis-X direction. The intermediate image 35 is the image formed on the screen S that is not enlarged but turned upside down in the axis-Y direction. FIGS. 14, 15, and 16 are light ray diagrams in the plane YZ.

The first optical system 31 includes the cross dichroic prism 19 and 15 lenses L1 to L15, as shown in FIG. 15. The lenses L1 to L15 are arranged in the presented order from the reduction side toward the enlargement side. In the present example, the lenses L2 and L3 are bonded to each other to form the first doublet L21. The lenses L4 and L5 are bonded to each other to form the second doublet L22. The lenses L11 and L12 are bonded to each other to form the third doublet L23. The lenses L13 and L14 are bonded to each other to form the fourth doublet L24. The light flux passage area of the lens L15 (first lens) is located at the lower side Y2 of the optical axis N.

The second optical system 32 includes a meniscus lens L16, which is disposed in the optical axis N of the first optical system 31, and the mirror M having a concave curved surface, as shown in FIG. 16. A surface of the meniscus lens L16 that is the surface facing the first optical system 31 is recessed in the direction away from the first optical system 31. A reflection coating layer 36 is provided on a surface of the meniscus lens L16 that is the surface opposite the first optical system 31. The mirror M is formed of the reflection coating layer 36. The mirror M reflects the light rays incident thereon from the first optical system 31 via the meniscus lens L16 toward the upper side Y1. The thickness of the meniscus lens L16 decreases with distance from the optical axis N in the axis-Y direction. In other words, the light rays that exit out of the first optical system 31 and pass through the meniscus lens L16 each travel along an optical path length in the meniscus lens L16 that decreases with distance from the optical axis N of the first optical system 31 toward the lower side Y2.

The third optical system 33 is formed of one lens L17 (second lens) having a meniscus shape. The lens L17 is disposed at the upper side Y1 of the optical axis N of the first optical system 31. The reduction-side surface of the lens L17 has a concave curved surface recessed toward the enlargement side. The reduction-side surface of the lens L17 has negative power. The reduction-side surface of the lens L17 is an aspheric surface. The enlargement-side surface of the lens L17 is a convex curved surface protruding toward the enlargement side. The enlargement-side surface of the lens L17 is an aspheric surface. The thickness of the lens L17 increases with distance from the optical axis N of the first optical system 31 toward the upper side Y1.

In the projection system 3D, the area A, where the optical density is maximized in the optical path from the reduction-side image formation plane to the enlargement-side image formation plane, is located between the second optical system 32 and the third optical system 33.

### Lens Data

Data on the lenses of the projection system 3D are as follows: The surfaces of the lenses are numbered sequentially from the reduction side toward the enlargement side. Reference characters are given to the lenses and the mirror. Reference character R denotes the radius of curvature of a lens surface or a mirror surface. Reference character D denotes the on-axis distance between surfaces. Reference character C denotes the effective diameter of a lens surface or a mirror surface. Reference characters R, D, and C are each expressed in millimeters.

| Reference | Surface | | | | Glass | Refraction/ | |
|---|---|---|---|---|---|---|---|
| character | number | Shape | R | D | material | reflection | C |
| | 0 | Spherical | Infinity | 0.0000 | | Refraction | 0.0000 |
| | 1 | Spherical | Infinity | 9.5000 | | Refraction | 11.7000 |
| 19 | 2 | Spherical | Infinity | 25.9100 | SBSL7 | Refraction | 13.3183 |
| | 3 | Spherical | Infinity | 0.0000 | | Refraction | 16.2023 |
| L1 | 4 | Spherical | 27.0317 | 9.8078 | SFPL51 | Refraction | 17.2638 |
| | 5 | Spherical | −91.7473 | 0.2000 | | Refraction | 16.9375 |
| L2 | 6 | Spherical | 30.0494 | 7.6112 | SFSL5 | Refraction | 14.8572 |
| L3 | 7 | Spherical | −59.1281 | 1.2000 | STIH6 | Refraction | 14.0000 |
| | 8 | Spherical | 48.0144 | 0.2000 | | Refraction | 12.8663 |
| L4 | 9 | Spherical | 20.3285 | 9.4745 | SBSL7 | Refraction | 12.3080 |
| L5 | 10 | Spherical | −21.8619 | 1.2000 | TAFD25 | Refraction | 11.5903 |
| | 11 | Spherical | 149.6514 | 0.5716 | | Refraction | 11.0183 |
| L6 | 12 | Aspheric | 42.1234 | 1.2000 | LBAL35 | Refraction | 10.9502 |
| | | surface | | | | | |
| | 13 | Aspheric | 20.5883 | 0.2000 | | Refraction | 10.6377 |
| | | surface | | | | | |
| L7 | 14 | Spherical | 19.5968 | 4.7218 | SFSL5 | Refraction | 10.7462 |
| | 15 | Spherical | 111.9897 | 4.5451 | | Refraction | 10.4362 |
| | 16 | Spherical | Infinity | 0.3081 | | Refraction | 9.6833 |
| L8 | 17 | Spherical | 32.4053 | 4.4372 | STIH53 | Refraction | 10.2937 |
| | 18 | Spherical | −70.0786 | 3.4909 | | Refraction | 10.3063 |
| L9 | 19 | Aspheric | −113.8987 | 4.9584 | LLAM60 | Refraction | 10.0091 |
| | | surface | | | | | |
| | 20 | Aspheric | 19.6728 | 5.4182 | | Refraction | 11.0032 |
| | | surface | | | | | |
| | 21 | Spherical | Infinity | 3.0514 | | Refraction | 12.8961 |
| L10 | 22 | Spherical | 49.7233 | 5.3687 | STIM22 | Refraction | 16.9655 |
| | 23 | Spherical | −389.0832 | 28.2696 | | Refraction | 17.2950 |
| L11 | 24 | Spherical | 53.8480 | 20.5720 | STIM2 | Refraction | 26.0000 |
| L12 | 25 | Spherical | −34.3085 | 1.2000 | STIH6 | Refraction | 25.9611 |
| | 26 | Spherical | 96.6824 | 3.7817 | | Refraction | 27.6369 |
| L13 | 27 | Spherical | 94.9435 | 11.3569 | STIL25 | Refraction | 29.9356 |
| L14 | 28 | Spherical | −103.4216 | 1.2000 | STIH6 | Refraction | 30.2208 |
| | 29 | Spherical | −117.6885 | 0.2000 | | Refraction | 30.4963 |
| L15 | 30 | Aspheric | −336.4398 | 3.3131 | □Z-E48R□ | Refraction | 31.3723 |
| | | surface | | | | | |
| | 31 | Aspheric | 75.2700 | 7.0933 | | Refraction | 31.0996 |
| | | surface | | | | | |
| | 32 | Spherical | Infinity | 0.0000 | | Refraction | 30.8623 |
| | 33 | Spherical | Infinity | 56.5805 | | Refraction | 30.8623 |
| L16 | 34 | Aspheric | −60.2160 | 3.0582 | □Z-E48R□ | Refraction | 30.7960 |
| | | surface | | | | | |
| M | 35 | Aspheric | −47.7619 | −3.0582 | □Z-E48R□ | Reflection | 31.5806 |
| | | surface | | | | | |
| L16 | 36 | Aspheric | −60.2160 | 0.0000 | | Refraction | 29.9102 |
| | | surface | | | | | |
| | 37 | Spherical | Infinity | −56.5805 | | Refraction | 44.1961 |
| L17 | 38 | Aspheric | 40.0796 | −1.2000 | □Z-E48R□ | Refraction | 34.6026 |
| | | surface | | | | | |
| | 39 | Aspheric | 197.8101 | 0.0000 | | Refraction | 49.5049 |
| | | surface | | | | | |
| | 40 | Spherical | Infinity | −444.4195 | | Refraction | 107.2002 |
| | 41 | Spherical | Infinity | 0.0000 | | Refraction | 1434.1834 |

The aspheric constants of each of the aspheric surfaces are listed below.

| Surface number | S12 | S13 | S19 | S20 |
|---|---|---|---|---|
| Radius of | 53.34221761 | 22.49128344 | −59.29150676 | 19.89273998 |
| curvature in | | | | |
| axis-Y direction | | | | |
| Conic constant | 1.568 | −1.3 | −1 | −0.88 |
| (K) | | | | |
| Fourth-order | −1.93783E−04 | −1.35859E−04 | −8.56185E−05 | −4.35212E−05 |
| coefficient (A) | | | | |
| Sixth-order | 1.56223E−06 | 1.61810E−06 | −6.83468E−08 | 5.26818E−08 |
| coefficient (B) | | | | |
| Eighth-order | −7.06670E−09 | −8.84670E−09 | −3.55359E−10 | −5.98134E−13 |
| coefficient (C) | | | | |
| Tenth-order | 1.36669E−11 | 1.88865E−11 | | |
| coefficient (D) | | | | |

| Surface number | S12 | S13 | S19 | S20 |
|---|---|---|---|---|
| Radius of | 42.12342595 | 20.58825946 | −113.8986936 | 19.67276682 |
| curvature in | | | | |
| axis-Y direction | | | | |
| Conic constant | 1.568 | −1.3 | −1 | −0.88 |
| (K) | | | | |
| Fourth-order | −1.99183E−04 | −1.55136E−04 | −6.79362E−05 | −3.70298E−05 |
| coefficient (A) | | | | |
| Sixth-order | 1.54723E−06 | 1.63860E−06 | −3.30297E−08 | 2.43777E−08 |
| coefficient (B) | | | | |
| Eighth-order | −6.53371E−09 | −7.91622E−09 | −2.02085E−10 | 1.85084E−11 |
| coefficient (C) | | | | |
| Tenth-order | 1.33431E−11 | 1.75764E−11 | | |
| coefficient (D) | | | | |
| Surface number | S30 | S31 | S34 | S35 |
| Radius of | −336.4398379 | 75.27004202 | −60.21601377 | −47.76186481 |
| curvature in | | | | |
| axis-Y direction | | | | |
| Conic constant | 90 | 0 | −0.008892814 | −1 |
| (K) | | | | |
| Fourth-order | 1.86571E−05 | −2.85543E−06 | −1.61721E−06 | 2.65449E−07 |
| coefficient (A) | | | | |
| Sixth-order | −1.53565E−08 | 1.55346E−08 | 5.23742E−10 | −3.00277E−10 |
| coefficient (B) | | | | |
| Eighth-order | 1.28759E−11 | −2.24983E−11 | −1.46010E−12 | −1.61591E−12 |
| coefficient (C) | | | | |
| Tenth-order | −1.25944E−14 | 5.64421E−15 | 3.68162E−15 | 3.44041E−15 |
| coefficient (D) | | | | |
| Twelfth-order | 6.41997E−18 | 5.23789E−18 | −2.59410E−18 | −2.53950E−18 |
| coefficient (E) | | | | |
| Fourteenth-order | −8.98575E−22 | −2.39098E−21 | 1.53594E−22 | 5.89213E−22 |
| coefficient (F) | | | | |

| Surface number | S36 | S38 | S39 |
|---|---|---|---|
| Radius of | −60.21601377 | 40.0795943 | 197.8101186 |
| curvature in | | | |
| axis-Y direction | | | |
| Conic constant | −0.008892814 | 0.115487402 | 12.22664516 |
| (K) | | | |
| Fourth-order | −1.61721E−06 | 9.08015E−07 | 2.46996E−06 |
| coefficient (A) | | | |
| Sixth-order | 5.23742E−10 | 4.77696E−10 | −5.58940E−10 |
| coefficient (B) | | | |
| Eighth-order | −1.46010E−12 | 7.45508E−13 | 1.09826E−13 |
| coefficient (C) | | | |
| Tenth-order | 3.68162E−15 | | |
| coefficient (D) | | | |
| Twelfth-order | −2.59410E−18 | | |
| coefficient (E) | | | |
| Fourteenth-order | 1.53594E−22 | | |
| coefficient (F) | | | |

The maximum object height, the brightness, the mirror radius, the final lens radius, the lens overall length, and TR of the projection system 3D are as follows:

| | |
|---|---|
| Maximum object height | 11.7 |
| NA | 0.3125 |
| Mirror radius | 31.6 |
| Final lens radius | 49.5 |
| Overall lens length | 240 |
| TR (0.59□WXGA) | 0.277 |

### Effects and Advantages

In the projection system 3D according to the present example, the lens L16, which is disposed in a position closest to the enlargement side in the first optical system 31, and the lens L17, which forms the third optical system 33, cannot be so provided as to form one optical element. The projection system 3D according to the present example, however, can provide the same effects and advantages as those provided by the projection system 3A described above except the aforementioned effect and advantage of one optical element containing the lenses L16 and L17.

In the present example, the second optical system 32 includes the meniscus lens L16 and the mirror M, which is formed of the reflection coating layer 36 provided on the meniscus lens L16. The light flux that exits out of the first optical system 31 and enters the second optical system 32 can therefore be refracted by the meniscus lens L16 and then reach the mirror M. The light rays reflected off the mirror M are refracted by the meniscus lens L16 and then caused to exit toward the third optical system 33. Therefore, in the present example, not only the mirror M reflects the light rays, but the meniscus lens L16 refracts the light rays twice. As described above, in the present example, the meniscus lens L16 can increase the angle of reflection of the light rays, whereby the size of the mirror M can be readily reduced.

The thickness of the meniscus lens L16 decreases with distance from the optical axis N in the axis-Y direction. The second optical system 32 is thus allowed to have power that causes the intermediate image 35 to be formed on the screen S. Further, since the meniscus lens L16 has refractive power, the power of the mirror M can be reduced. The curved shape of the mirror M can thus be gentler, whereby the size of the mirror M can be readily reduced.

In the present example, the lens L15, which is located in a position closest to the enlargement side in the first optical system 31, has positive power. The divergence of the light flux that exits out of the first optical system and enters the second optical system 32 can thus be suppressed, whereby the size of the mirror M can be readily reduced.

The third optical system 33 may further include a lens at the enlargement side of the lens L17.

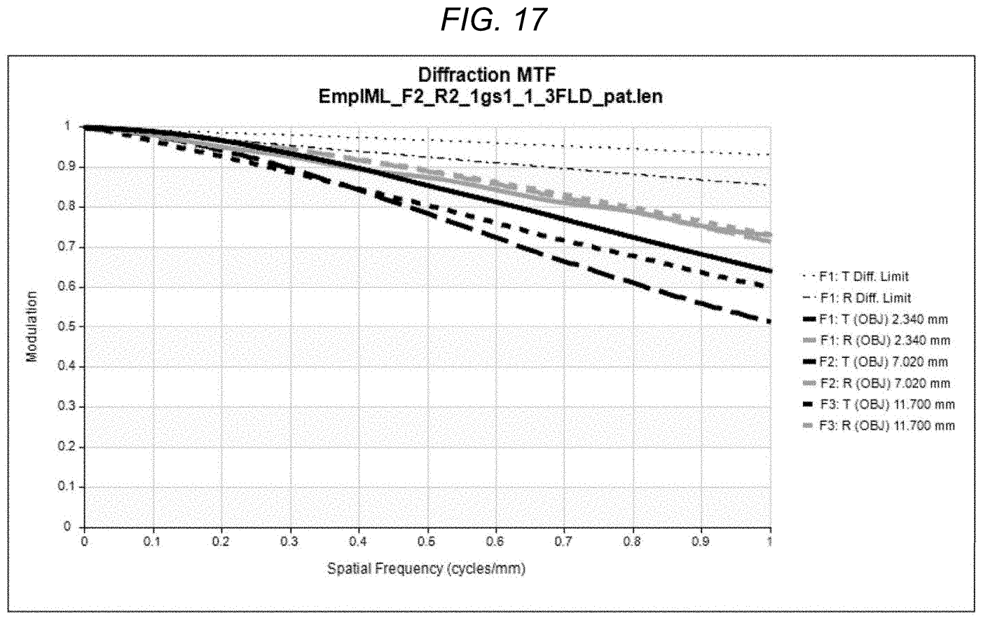

FIG. 17 shows the enlargement-side MTF of the projection system 3D. The projection system 3D according to the present example provides high resolution, as shown in FIG. 17.

### Example 5

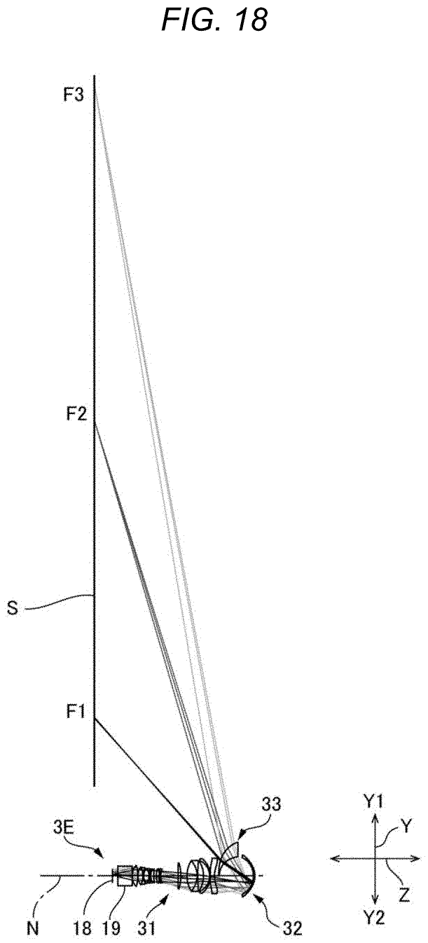

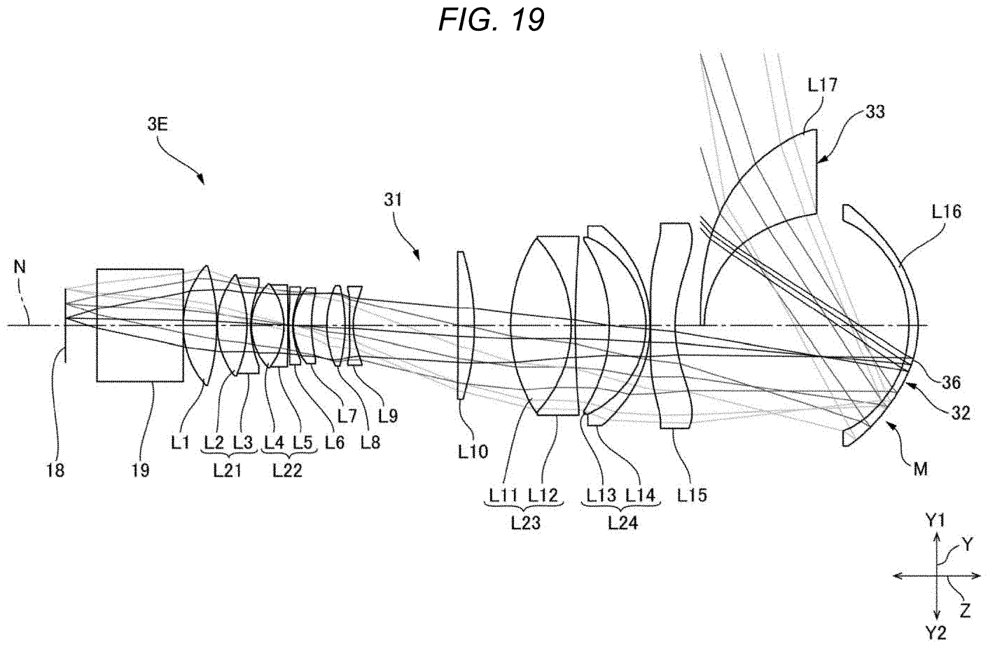

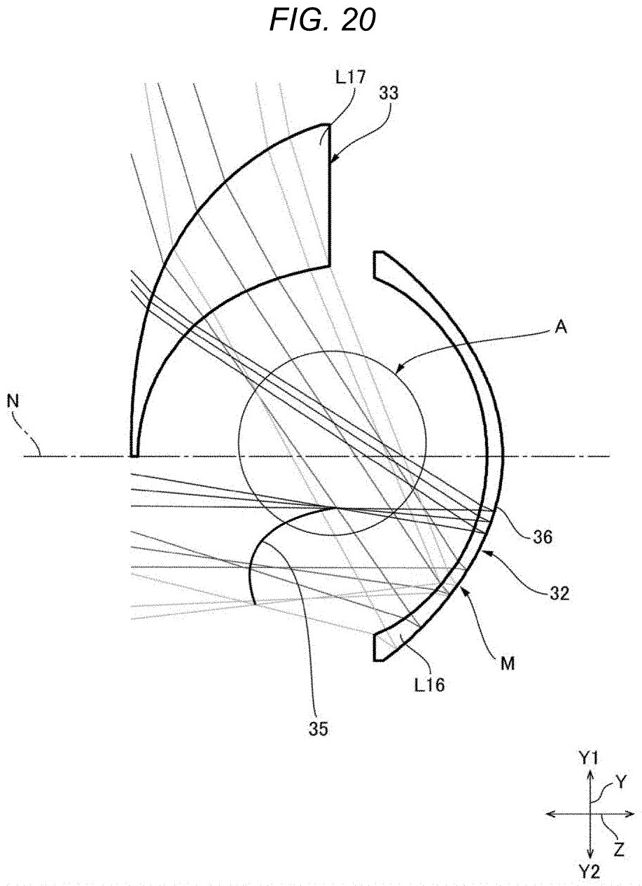

FIG. 18 is a light ray diagram diagrammatically showing the entire projection system according to Example 5. FIG. 18 diagrammatically shows light fluxes that exit out of a projection system 3E according to the present example and reach the screen S in the form of the light fluxes F1 to F3. FIG. 19 is a light ray diagram of the light rays passing through the projection system according to Example 5. FIG. 20 is a light ray diagram in the vicinity of the second optical system and the third optical system. The projection system 3E according to Example 5 has a configuration corresponding to that of the projection system 3D described above, and corresponding components therefore have the same reference characters in the description.

The projection system 3E according to the present example is formed of the first optical system 31, the second optical system 32, and the third optical system 33 sequentially arranged from the reduction side toward the enlargement side, as shown in FIG. 19. The first optical system 31 is a refractive optical system including a plurality of lenses. The second optical system 32 includes the mirror M having a concave curved surface. The third optical system 33 has negative power. The first optical system 31 forms the intermediate image 35, which is conjugate with the reduction-side image formation plane, between the first optical system 31 and the second optical system 32, as shown in FIG. 20. The second optical system 32 and the third optical system 33 form a final image conjugate with the intermediate image 35 in the enlargement-side image formation plane. The liquid crystal panels 18 located in the reduction-side image formation plane form projection images at the upper side Y1 of the optical axis N. The intermediate image 35 is formed at the lower side Y2 of the optical axis N. The screen S disposed in the enlargement-side image formation plane is located at the upper side Y1 of the optical axis N. The lateral direction of the screen S coincides with the axis-X direction. The intermediate image 35 is the image formed on the screen S that is not enlarged but turned upside down in the axis-Y direction. FIGS. 18, 19, and 20 are light ray diagrams in the plane YZ.

The first optical system 31 includes the cross dichroic prism 19 and 15 lenses L1 to L15, as shown in FIG. 19. The lenses L1 to L15 are arranged in the presented order from the reduction side toward the enlargement side. In the present example, the lenses L2 and L3 are bonded to each other to form the first doublet L21. The lenses L4 and L5 are bonded to each other to form the second doublet L22. The lenses L11 and L12 are bonded to each other to form the third doublet L23. The lenses L13 and L14 are bonded to each other to form the fourth doublet L24. The light flux passage area of the lens L15 (first lens) is located at the lower side Y2 of the optical axis N.

The second optical system 32 includes the meniscus lens L16, which is disposed in the optical axis N of the first optical system 31, and the mirror M having a concave curved surface, as shown in FIG. 20. A surface of the meniscus lens L16 that is the surface facing the first optical system 31 is recessed in the direction away from the first optical system 31. The reflection coating layer 36 is provided on a surface of the meniscus lens L16 that is the surface opposite the first optical system 31. The mirror M is formed of the reflection coating layer 36. The mirror M reflects the light rays incident thereon from the first optical system 31 via the meniscus lens L16 toward the upper side Y1.

The third optical system 33 is formed of one lens L17 (second lens) having a meniscus shape. The lens L17 is disposed at the upper side Y1 of the optical axis N of the first optical system 31. The reduction-side surface of the lens L17 has a concave curved surface recessed toward the enlargement side. The reduction-side surface of the lens L17 has negative power. The reduction-side surface of the lens L17 is an aspheric surface. The enlargement-side surface of the lens L17 is a convex curved surface protruding toward the enlargement side. The enlargement-side surface of the lens L17 is an aspheric surface. The thickness of the lens L17 increases with distance from the optical axis N of the first optical system 31 toward the upper side Y1.

In the projection system 3E, the area A, where the optical density is maximized in the optical path from the reduction-side image formation plane to the enlargement-side image formation plane, is located between the second optical system 32 and the third optical system 33.

### Lens Data

Data on the lenses of the projection system 3E are as follows: The surfaces of the lenses are numbered sequentially from the reduction side toward the enlargement side. Reference characters are given to the lenses and the mirror. Reference character R denotes the radius of curvature of a lens surface or a mirror surface. Reference character D denotes the on-axis distance between surfaces. Reference character C denotes the effective diameter of a lens surface or a mirror surface. Reference characters R, D, and C are each expressed in millimeters.

| Reference | Surface | | | | Glass | Refraction/ | |
|---|---|---|---|---|---|---|---|
| character | number | Shape | R | D | material | reflection | C |
| | 0 | Spherical | Infinity | 0.0000 | | Refraction | 0.0000 |
| | 1 | Spherical | Infinity | 9.5000 | | Refraction | 11.7000 |
| 19 | 2 | Spherical | Infinity | 25.9100 | SBSL7 | Refraction | 13.4739 |
| | 3 | Spherical | Infinity | 0.0000 | | Refraction | 16.6300 |
| L1 | 4 | Spherical | 29.8694 | 10.1212 | 507907.7482 | Refraction | 17.7171 |
| | 5 | Spherical | −67.4125 | 0.2000 | | Refraction | 17.4566 |
| L2 | 6 | Spherical | 27.2314 | 8.9026 | 480546.8087 | Refraction | 14.9087 |
| L3 | 7 | Spherical | −41.0845 | 1.2000 | 841641.2724 | Refraction | 14.0000 |
| | 8 | Spherical | 34.9494 | 0.2000 | | Refraction | 12.7097 |
| L4 | 9 | Spherical | 20.3128 | 9.7814 | 512784.739 | Refraction | 12.5602 |
| L5 | 10 | Spherical | −22.5939 | 1.2000 | 836218.3898 | Refraction | 11.9719 |
| | 11 | Spherical | −445.9411 | 0.2000 | | Refraction | 11.5039 |
| L6 | 12 | Aspheric | 43.2803 | 1.2664 | 680891.3828 | Refraction | 11.3626 |
| | | surface | | | | | |
| | 13 | Aspheric | 20.5080 | 0.2000 | | Refraction | 10.9467 |
| | | surface | | | | | |
| L7 | 14 | Spherical | 20.3468 | 5.4927 | 457217.8557 | Refraction | 11.0447 |
| | 15 | Spherical | 51.1219 | 3.7826 | | Refraction | 10.5735 |
| | 16 | Spherical | Infinity | 0.7848 | | Refraction | 10.3442 |
| L8 | 17 | Spherical | 32.8048 | 5.5105 | 846613.2379 | Refraction | 11.6466 |
| | 18 | Spherical | −50.5221 | 1.2407 | | Refraction | 11.7007 |
| L9 | 19 | Aspheric | 86.0385 | 1.2128 | 793362.4698 | Refraction | 11.3524 |
| | | surface | | | | | |
| | 20 | Aspheric | 21.2155 | 18.1704 | | Refraction | 11.5237 |
| | | surface | | | | | |
| | 21 | Spherical | Infinity | 13.4313 | | Refraction | 17.0204 |
| L10 | 22 | Spherical | −1615.9383 | 4.8741 | 609228.3456 | Refraction | 21.6521 |
| | 23 | Spherical | −82.2654 | 10.9859 | | Refraction | 22.0804 |
| L11 | 24 | Spherical | 54.4549 | 18.2441 | 614134.343 | Refraction | 26.6000 |
| L12 | 25 | Spherical | −42.3381 | 1.2007 | 846663.2378 | Refraction | 26.4607 |
| | 26 | Spherical | 343.3072 | 10.3212 | | Refraction | 26.9555 |
| L13 | 27 | Spherical | −51.5322 | 10.9749 | 632600.3261 | Refraction | 27.1806 |
| L14 | 28 | Spherical | −31.5200 | 1.2716 | 846663.2378 | Refraction | 27.8268 |
| | 29 | Spherical | −42.0428 | 0.2009 | | Refraction | 30.1604 |
| L15 | 30 | Aspheric | −316.6043 | 7.3099 | □Z-E48R□ | Refraction | 30.8006 |
| | | surface | | | | | |
| | 31 | Aspheric | 41.0756 | 8.8391 | | Refraction | 30.9558 |
| | | surface | | | | | |
| | 32 | Spherical | Infinity | 0.0000 | | Refraction | 30.4576 |
| | 33 | Spherical | Infinity | 61.6812 | | Refraction | 30.4576 |
| L16 | 34 | Aspheric | −44.4514 | 2.7888 | □Z-E48R□ | Refraction | 33.6082 |
| | | surface | | | | | |
| M | 35 | Aspheric | −36.0879 | −2.7888 | □Z-E48R□ | Reflection | 36.5870 |
| | | surface | | | | | |
| L16 | 36 | Aspheric | −44.4514 | 0.0000 | | Refraction | 32.7646 |
| | | surface | | | | | |
| | 37 | Spherical | Infinity | −61.6812 | | Refraction | 67.4665 |
| L17 | 38 | Aspheric | 35.2091 | −1.2025 | □Z-E48R□ | Refraction | 35.7627 |
| | | surface | | | | | |
| | 39 | Aspheric | 184.3284 | 0.0000 | | Refraction | 59.9902 |
| | | surface | | | | | |
| | 40 | Spherical | Infinity | −224.4195 | | Refraction | 218.5843 |
| | 41 | Spherical | Infinity | 0.0000 | | Refraction | 1488.5872 |

The aspheric constants of each of the aspheric surfaces are listed below.

| Surface number | S12 | S13 | S19 | S20 |
|---|---|---|---|---|
| Radius of | 43.28029149 | 20.50803314 | 86.03847258 | 21.21553721 |
| curvature in | | | | |
| axis-Y direction | | | | |
| Conic constant | 1.568 | −1.3 | −1 | −0.88 |
| (K) | | | | |
| Fourth-order | −1.58537E−04 | −1.17452E−04 | −7.01987E−05 | −4.77470E−05 |
| coefficient (A) | | | | |
| Sixth-order | 9.55101E−07 | 1.02304E−06 | 3.87255E−08 | 5.99956E−08 |
| coefficient (B) | | | | |
| Eighth-order | −3.05979E−09 | −3.81639E−09 | −2.71036E−10 | −1.71069E−10 |
| coefficient (C) | | | | |
| Tenth-order | 4.81421E−12 | 6.84466E−12 | | |
| coefficient (D) | | | | |

| Surface number | S30 | S31 | S34 | S35 |
|---|---|---|---|---|
| Radius of | −316.6043306 | 41.07563553 | −44.45142177 | −36.08791139 |
| curvature in | | | | |
| axis-Y direction | | | | |
| Conic constant | 90 | 0 | 0.582889825 | −1 |
| (K) | | | | |
| Fourth-order | 1.51233E−05 | −1.22055E−05 | −3.29891E−06 | 1.11825E−06 |
| coefficient (A) | | | | |
| Sixth-order | −1.67413E−08 | 1.54800E−08 | 4.58126E−09 | −1.21257E−09 |
| coefficient (B) | | | | |
| Eighth-order | 1.48808E−11 | −2.22732E−11 | −5.29526E−12 | −1.25146E−12 |
| coefficient (C) | | | | |
| Tenth-order | −1.25723E−14 | 6.54334E−15 | 5.28622E−15 | 3.40742E−15 |
| coefficient (D) | | | | |
| Twelfth-order | 5.84164E−18 | 5.29981E−18 | −1.32591E−18 | −2.54861E−18 |
| coefficient (E) | | | | |
| Fourteenth-order | −1.11131E−21 | −3.14911E−21 | −5.28881E−22 | 6.04186E−22 |
| coefficient (F) | | | | |

| Surface number | S36 | S38 | S39 |
|---|---|---|---|
| Radius of | −44.45142177 | 35.20906928 | 184.3283787 |
| curvature in | | | |
| axis-Y direction | | | |
| Conic constant | 0.582889825 | −0.064848482 | 7.605219081 |
| (K) | | | |
| Fourth-order | −3.29891E−06 | −6.47726E−07 | 1.50866E−06 |
| coefficient (A) | | | |
| Sixth-order | 4.58126E−09 | 1.15778E−09 | −2.51376E−10 |
| coefficient (B) | | | |
| Eighth-order | −5.29526E−12 | 7.21849E−13 | 3.07333E−14 |
| coefficient (C) | | | |

The maximum object height, the brightness, the mirror radius, the final lens radius, the lens overall length, and TR of the projection system 3E are as follows:

| | |
|---|---|
| Maximum object height | 11.7 |
| NA | 0.3125 |
| Mirror radius | 36.6 |
| Final lens radius | 60.0 |
| Overall lens length | 257 |
| TR (0.59□WXGA) | 0.138 |

### Effects and Advantages

The projection system 3E according to the present example can provide the same effects and advantages as those provided by the projection system 3D described above. In the present example, the thickness of the meniscus lens L16 of the second optical system 32 does not decrease with distance from the optical axis N in the axis-Y direction. The refractive power of the second optical system 32 is therefore smaller than that of the projection system 3D. The size of the mirror M therefore increases as compared with that in the projection system 3D.

The third optical system 33 may further include a lens at the enlargement side of the lens L17.

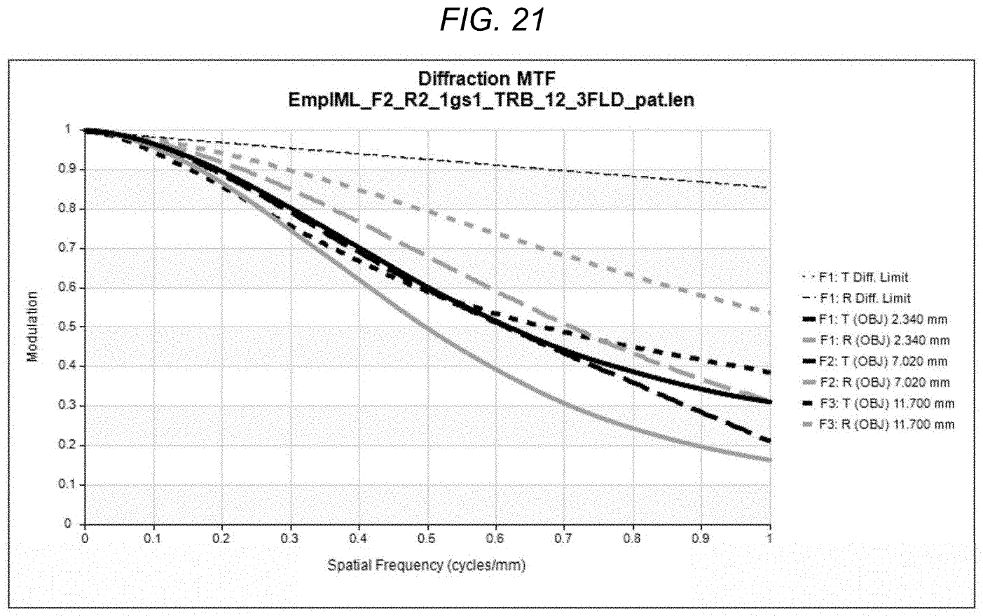

FIG. 21 shows the enlargement-side MTF of the projection system 3E. The projection system 3E according to the present example provides high resolution, as shown in FIG. 21.

In each of the examples described above, the first optical system 31 forms an intermediate image once, and the present disclosure is also applicable to a first optical system 31 that forms an intermediate image multiple times. Further, in the examples described above, the lens disposed in a position closest to the enlargement side in the first optical system 31 and the lens disposed in a position closest to the reduction side in the third optical system 33 each have an aspheric surface, and the lenses may each be formed of spherical surfaces.

What is claimed is:

1. A projection system comprising:
a first optical system;
a second optical system disposed at an enlargement side of the first optical system; and
a third optical system disposed at the enlargement side of the second optical system,
wherein an intermediate image conjugate with a reduction-side image formation plane is formed between the first optical system and the second optical system,
the first optical system includes a first lens disposed in a position closest to the enlargement side in the first optical system,
the second optical system includes a mirror having a concave curved surface,
the third optical system includes a second lens disposed in a position closest to the reduction side in the third optical system, the second lens having negative power,
an effective range of the first lens is located at one side of an optical axis of the first optical system, and
an effective range of the second lens is located at other side of the optical axis.

2. The projection system according to claim 1,
wherein the second lens includes a concave curved surface recessed toward the enlargement side, the concave curved surface being a surface facing the reduction side of the second lens.

3. The projection system according to claim 2,
wherein the first lens and the second lens are integrated with each other into an optical element,
the optical element is disposed in the optical axis at an opposite side of the second optical system with respect to the intermediate image,
the first lens is located in the optical element at the one side of the optical axis, and
the second lens is located in the optical element at the other side of the optical axis.

4. The projection system according to claim 3,
wherein the first lens includes
a concave curved surface recessed toward the reduction side, the concave curved surface being a surface facing the enlargement side of the first lens, and
a convex surface protruding toward the reduction side, the convex surface being a surface facing the reduction side of the first lens,
the second lens includes a convex surface protruding toward the enlargement side, the convex surface being a surface facing the enlargement side of the second lens, and
the optical element is a meniscus lens.

5. The projection system according to claim 1,
wherein the second optical system further includes a meniscus lens disposed in the optical axis in a position closer to the first optical system than the mirror,
a surface of the meniscus lens that is a surface facing the first optical system is recessed in a direction away from the first optical system, and
the mirror is provided on a surface of the meniscus lens that is a surface opposite the first optical system.

6. The projection system according to claim 1,
wherein an area where optical density is maximized in an optical path from the reduction-side image formation plane to an enlargement-side image formation plane is located between the second optical system and the third optical system.

7. A projector comprising:
a light source;
a light modulator modulating light emitted from the light source to form an image on the reduction-side image formation plane; and
the projection system according to claim 1, which projects the image.

8. A projector comprising:
a light source;
a light modulator modulating light emitted from the light source to form an image on the reduction-side image formation plane; and
the projection system according to claim 2, which projects the image.

9. A projector comprising:
a light source;
a light modulator modulating light emitted from the light source to form an image on the reduction-side image formation plane; and
the projection system according to claim 3, which projects the image.

10. A projector comprising:
a light source;
a light modulator modulating light emitted from the light source to form an image on the reduction-side image formation plane; and
the projection system according to claim 4, which projects the image.

11. A projector comprising:
a light source;
a light modulator modulating light emitted from the light source to form an image on the reduction-side image formation plane; and
the projection system according to claim 5, which projects the image.

12. A projector comprising:
a light source;
a light modulator modulating light emitted from the light source to form an image on the reduction-side image formation plane; and
the projection system according to claim 6, which projects the image.
